(19) United States
(12) Patent Application Publication
(10) Pub. No.: US 2010/0226629 A1
(43) Pub. Date: Sep. 9, 2010

(54) ROLL-TO-ROLL PROCESSING AND TOOLS FOR THIN FILM SOLAR CELL MANUFACTURING

(75) Inventors: Bulent M. Basol, Manhattan Beach, CA (US); Howard Zolla, Los Gatos, CA (US); Mustafa Pinarbasi, Morgan Hill, CA (US); Gregory Norsworthy, San Jose, CA (US)

Correspondence Address: PILLSBURY WINTHROP SHAW PITTMAN LLP, P.O. BOX 10500, MCLEAN, VA, 22102, US

(73) Assignee: SOLOPOWER, INC., San Jose, CA (US)

(21) Appl. No.: 12/721,446

(22) Filed: Mar. 10, 2010

Related U.S. Application Data
(63) Continuation-in-part of application No. 12/334,420, filed on Dec. 12, 2008.
Application No. 12/334,420 is a continuation-in-part of application No. 12/177,007, filed on Jul. 21, 2008.
Application No. 12/177,007 is a continuation-in-part of application No. 12/345,389, filed on Dec. 29, 2008.
Application No. 12/345,389 is a continuation-in-part of application No. 12/642,716, filed on Dec. 18, 2009.
(60) Provisional application No. 61/159,053, filed on Mar. 10, 2009.
(60) Provisional application No. 61/161,377, filed on Mar. 18, 2009.
(60) Provisional application No. 61/162,235, filed on Mar. 20, 2009.

(51) Int. Cl. F26B 3/28; F24F 7/00; F26B 3/34

(52) U.S. Cl. 392/407; 454/339; 34/247; 34/259

(57) ABSTRACT

Described are roll-to-roll or reel-to-reel thermal or rapid thermal processing tools (reactors) are used to react a precursor layer on a continuous flexible workpiece. Variants of the reactors are described, including a reactor having multiple exhaust outlets connected to a process gap of the reactor between an entrance opening and an exit opening of the process gap; a reactor including multiple gas inlets and exhaust outlets connected to a process gap of the reactor between an entrance opening and an exit opening of the process gap; a reactor including multiple gas inlets and exhaust outlets connected to a process gap of the reactor between an entrance opening and an exit opening of the process gap; and a reactor including multiple gas inlets and exhaust outlets connected to a process gap of the reactor between an entrance opening and an exit opening of the process gap. Also described is an exhaust system that separates the Group VIA material vapors from other gaseous species for re-cycling or easy disposal and techniques and apparatus for efficient removal of moisture from the workpiece before processing precursor layer in the RTP tool.

### CROSS REFERENCE TO RELATED APPLICATIONS

This application claims priority to U.S. Provisional Application No. 61/159053 filed Mar. 10, 2009 entitled “EXHAUST SYSTEM FOR ROLL TO ROLL REACTORS EXHAUST SYSTEM FOR ROLL TO ROLL REACTORS”, and this application claims priority to U.S. Provisional Application No. 61/161377 filed Mar. 18, 2009 entitled “MOISTURE CAPTURE IN UNWIND AND REWIND STATIONS OF ROLL TO ROLL REACTORS”, and this claims priority to U.S. Provisional Application No. 61/162235 filed Mar. 20, 2009 entitled “ROLL-TO-ROLL PROCESSING AND TOOLS FOR THIN FILM SOLAR CELL MANUFACTURING”; and this application claims priority to and is a Continuation-in-Part of U.S. patent application Ser. No. 12/344420 filed Dec. 12, 2008, entitled “REACTOR TO FORM SOLAR CELL ABSORBERS” and this application claims priority to and is a Continuation-in-Part of U.S. patent application Ser. No. 12/177007 filed Jul. 21, 2008 entitled “METHOD AND APPARATUS TO FORM THIN LAYERS OF PHOTOVOLTAIC ABSORBERS”; and this application claims priority to and is a Continuation-in-Part of U.S. patent application Ser. No. 12/345389 filed Dec. 29, 2008 entitled “METHOD AND APPARATUS TO FORM SOLAR CELL ABSORBER LAYERS WITH PLANAR SURFACE”; and this application claims priority to and is a Continuation-in-Part of U.S. patent application Ser. No. 12/642716 filed Dec. 18, 2009 entitled “REACTOR TO FORM SOLAR CELL ABSORBERS IN A ROLL-TO-ROLL FASHION”; all of the above-referenced applications are incorporated herein by reference.

### BACKGROUND OF THE INVENTION

1. Field of the Inventions

The present invention relates to method and apparatus for preparing thin films of semiconductor materials for radiation detector and photovoltaic applications.

2. Description of the Related Art

Solar cells are photovoltaic devices that convert sunlight directly into electrical power. The most common solar cell material is silicon, which is in the form of single or polycrystalline wafers. However, the cost of electricity generated using silicon-based solar cells is higher than the cost of electricity generated by the more traditional methods. Therefore, since the early 1970's there has been an effort to reduce the cost of solar cells for terrestrial use. One way of reducing the cost of solar cells is to develop low-cost thin film growth techniques that can deposit solar-cell-quality absorber materials on large area substrates and to fabricate these devices using high-throughput, low-cost methods.

Group IBIIIAVIA compound semiconductors including some of the Group IB (Cu, Ag, Au), Group IIIA (B, Al, Ga, In, Tl) and Group VIA (0, S, Se, Te, Po) materials or elements of the periodic table are excellent absorber materials for thin film solar cell structures. Compounds of Cu, In, Ga, Se and S which are generally referred to as CIGS(S), or Cu(In,Ga)(S,Se)₂ or CuIn₁₋ₓGaₓ (S_{y}Se_{1-y})ₖ, where 0≦x≦1, 0≦y≦1 and k is approximately 2, have already been employed in solar cell structures that have yielded conversion efficiencies approaching 20%. Absorbers containing Group IIIA element Al and/or Group VIA element Te also showed promise. In summary, compounds containing: i) Cu from Group IB, ii) at least one of In, Ga, and Al from Group IIIA, and iii) at least one of S, Se, and Te from Group VIA, are of great interest for solar cell applications.

The structure of a conventional Group IBIIIAVIA compound photovoltaic cell such as a Cu(In,Ga,Al)(S,Se,Te)₂ thin film solar cell is shown in FIG. 1. The device 10 is fabricated on a substrate 11, such as a sheet of glass, a sheet of metal, an insulating foil or web, or a conductive foil or web. The absorber film 12, which includes a material in the family of Cu(In,Ga,Al)(S,Se,Te)₂, is grown over a conductive layer 13 or contact layer, which is previously deposited on the substrate 11 and which acts as the electrical contact to the device. The substrate 11 and the contact layer 13 form a base 20. Various conductive layers including Mo, Ta, W, Ti, and stainless steel etc. have been used in the solar cell structure of FIG. 1. If the substrate itself is a properly selected conductive material, it is possible not to use a contact layer 13, since the substrate 11 may then be used as the ohmic contact to the device. After the absorber film 12 is grown, a transparent conductive layer 14 such as a CdS, ZnO or CdS/ZnO stack is formed on the absorber film. Radiation 15 enters the device through the transparent layer 14. Metallic grids (not shown) may also be deposited over the transparent layer 14 to reduce the effective series resistance of the device. The preferred electrical type of the absorber film 12 is p-type, and the preferred electrical type of the transparent layer 14 is n-type. However, an n-type absorber and a p-type window layer can also be utilized. The preferred device structure of FIG. 1 is called a “substrate-type” structure. A “superstrate-type” structure can also be constructed by depositing a transparent conductive layer on a transparent superstrate such as glass or transparent polymeric foil, and then depositing the Cu(In,Ga,Al)(S,Se,Te)₂ absorber film, and finally forming an ohmic contact to the device by a conductive layer. In this superstrate structure light enters the device from the transparent superstrate side. A variety of materials, deposited by a variety of methods, can be used to provide the various layers of the device shown in FIG. 1.

In a thin film solar cell employing a Group IBIIIAVIA compound absorber, the cell efficiency is a strong function of the molar ratio of IB/IIIA. If there are more than one Group IIIA materials in the composition, the relative amounts or molar ratios of these IIIA elements also affect the properties. For a Cu(In,Ga)(S,Se)₂ absorber layer, for example, the efficiency of the device is a function of the molar ratio of Cu/(In+Ga). Furthermore, some of the important parameters of the cell, such as its open circuit voltage, short circuit current and fill factor vary with the molar ratio of the IIIA elements, i.e. the Ga/(Ga+In) molar ratio. In general, for good device performance, the Cu/(In+Ga) molar ratio is kept at around or below 1.0. As the Ga/(Ga+In) molar ratio increases, on the other hand, the optical bandgap of the absorber layer increases and therefore the open circuit voltage of the solar cell increases while the short circuit current typically may decrease. It is important for a thin film deposition process to have the capability of controlling both the molar ratio of IB/IIIA, and the molar ratios of the Group IIIA components in the composition. It should be noted that although the chemical formula is often written as Cu(In,Ga)(S,Se)₂, a more accurate formula for the compound is Cu(In,Ga)(S,Se)ₖ, where k is typically close to 2 but may not be exactly 2. For simplicity we will continue to use the value of k as 2. It should be further noted that the notation “Cu(X,Y)” in the chemical formula means all chemical compositions of X and Y from (X=0% and Y=100%) to (X=100% and Y=0%). For example, Cu(In,Ga) means all compositions from CuIn to CuGa. Similarly, Cu(In,Ga)(S,Se)₂ means the whole family of compounds with the Ga/(Ga+In) molar ratio varying from 0 to 1, and the Se/(Se+S) molar ratio varying from 0 to 1.

One technique for growing Cu(In,Ga)(S,Se)₂ type compound thin films for solar cell applications is a two-stage process where metallic components of the Cu(In,Ga)(S,Se)₂ material are first deposited onto a substrate, and then reacted with S and/or Se in a high temperature annealing process. For example, for CuInSe₂ growth, thin layers of Cu and In are first deposited on a substrate and then this stacked precursor layer is reacted with Se at elevated temperature. If the reaction atmosphere also contains sulfur, then a Culn(S,Se)₂ layer can be grown. Addition of Ga in the precursor layer, i.e. use of a Cu/In/Ga stacked film precursor, allows the growth of a Cu(In,Ga)(S,Se)₂ absorber.

Two-stage process approach may also employ stacked layers including Group VIA materials. For example, a Cu(In,Ga)Se₂ film may be obtained by depositing In—Ga—Se and Cu—Se layers in an In—Ga—Se/Cu—Se stack and reacting them in presence of Se. Similarly, stacks including Group VIA materials and metallic components may also be used. Stacks including Group VIA materials include, but are not limited to In—Ga—Se/Cu stack, Cu/In/Ga/Se stack, Cu/Se/In/Ga/Se stack, etc.

Selenization and/or sulfidation (or sulfurization) of precursor layers including metallic components may be carried out in various forms of Group VIA material(s). One approach involves using gases such as H₂Se, H₂S or their mixtures to react, either simultaneously or consecutively, with the precursor including Cu, In and/or Ga. This way a Cu(In,Ga)(S,Se)₂ film may be formed after annealing and reacting at elevated temperatures. It is possible to increase the reaction rate or reactivity by striking plasma in the reactive gas during the process of compound formation. Se vapors or S vapors from elemental sources may also be used for selenization and sulfidation. Alternately, as described before, Se and/or S may be deposited over the precursor layer including Cu, In and/or Ga and the stacked structure can be annealed at elevated temperatures to initiate reaction between the metallic elements or components and the Group VIA material(s) to form the Cu(In,Ga)(S,Se)₂ compound.

Reaction step in a two-stage process is typically carried out in batch furnaces. In this approach, a number of pre-cut substrates, typically glass substrates, with precursor layers deposited on them are placed into a batch furnace and reaction is carried out for periods that may range from 15 minutes to several hours. Temperature of the batch furnace is typically raised to the reaction temperature, which may be in the range of 400-600° C., after loading the substrates. The ramp rate for this temperature rise is normally lower than 5° C./sec, typically less than 1° C./sec. This slow heating process works for selenizing metallic precursors (such as precursor layers containing only Cu, In and/or Ga) using gaseous Se sources such as H₂Se or organometallic Se sources. For precursors containing solid Se, however, slow ramp rate causes Se de-wetting and morphological problems. For example, reacting a precursor layer with a structure of base/Cu/In/Se by placing it in a batch furnace with a low temperature rise rate (such as 1° C./sec) yields films that are powdery and non-uniform. Such films do not yield high efficiency solar cells.

One prior art method described in U.S. Pat. No. 5,578,503 utilizes a rapid thermal annealing (RTP) approach to react the precursor layers in a batch manner, one substrate at a time. Such RTP approaches are also disclosed in various publications (see, for example, Mooney et al., Solar Cells, vol:30, p:69, 1991, Gabor et al., AIP Conf. Proc. #268, PV Advanced Research & Development Project, p:236, 1992, and Kerr et al., IEEE Photovoltaics Specialist Conf., p:676, 2002). In the prior art RTP reactor design the temperature of the substrate with the precursor layer is raised to the reaction temperature at a high rate, typically at 10° C./sec. It is believed that such high temperature rise through the melting point of Se (220° C.) avoids the problem of de-wetting and thus yields films with good morphology.

Design of the reaction chamber to carry out selenization/sulfidation processes is critical for the quality of the resulting compound film, the efficiency of the solar cells, throughput, material utilization and cost of the process. From the foregoing, there is a need for methods and apparatus to carry out reaction of precursor layers for CIGS(S) type absorber formation, in a roll-to-roll manner. Roll-to-roll or reel-to-reel processing increases throughput and minimizes substrate handling. Therefore, it is a preferred method for large scale manufacturing of flexible solar cell structures.

### SUMMARY

The present inventions provide methods and integrated tools to form solar cell absorber layers on continuous flexible substrates. Roll-to-roll or reel-to-reel thermal or rapid thermal processing (RTP) tools (reactors) are used to react a precursor layer on a continuous flexible workpiece.

Several embodiments are given for the roll-to-roll tools that improve their versatility and the quality of the semiconductor absorber layers processed using such reactors.

An aspect of the present invention includes a reactor having multiple exhaust outlets connected to a process gap of the reactor between an entrance opening and an exit opening of the process gap. The entrance opening and the exit opening of the process gap are open to the atmosphere. By controlling each exhaust outlet independently with valves, process times of a precursor layer in different sections of the process gap may be extended or shortened. This versatility of the reactor allows conversion of precursor layers into absorber layers having different compositions and molar ratios using the reactor of the present invention.

Another aspect of the present invention includes a reactor including multiple gas inlets and exhaust outlets connected to a process gap of the reactor between an entrance opening and an exit opening of the process gap. The entrance opening and an exit opening of the process gap may be open to the atmosphere. A first gas inlet is connected adjacent the entrance opening and a second gas inlet is connected adjacent the exit opening of the process gap so that when an inert gas is applied through the first and second gas inlets, the inert gas flow forms a diffusion barrier, namely a first diffusion barrier and a second diffusion barrier, efficiently sealing the entrance and exit openings. A vacuum pump connected to an exhaust outlet which is placed between the first and second gas inlets and connected to the process gap establishes gas flows within the process gap from the first and second gas inlets towards the exhaust outlet such that these gas flows prevent the process gases within the process gap from leaving the process gap through the entrance opening and the exit opening.

Another aspect of the present invention includes a reactor including multiple gas inlets and exhaust outlets connected to a process gap of the reactor between an entrance opening and an exit opening of the process gap. A supply chamber or unwind port is connected to the entrance opening of the process gap and the exit opening is open to the atmosphere. A first diffusion barrier is formed at the entrance opening by applying an inert gas flow through an external gas inlet connected to the supply chamber. The flow of this inert gas into the process gap is controlled by a gas outlet connected adjacent the entrance opening of the process gap.

Another aspect of the present invention includes a reactor including multiple gas inlets and exhaust outlets connected to a process gap of the reactor between an entrance opening and an exit opening of the process gap. The ends of the process gap are sealed with a supply chamber or unwind chamber and a receiving chamber or rewind chamber. Accordingly, a first diffusion barrier is formed at the entrance opening of the process gap; a second diffusion barrier may be formed at the exit opening of the process gap; and a third diffusion barrier may be formed between the first and the second diffusion barriers.

Another aspect of the present invention includes an exhaust system separates the Group VIA material vapors from other gaseous species for re-cycling or easy disposal.

Yet another aspect of the present invention includes a technique and apparatus for efficient removal of moisture from the workpiece before processing precursor layer in the roll-to-roll rapid thermal processing (RTP) tool.

In a preferred aspect is provided an apparatus used to react precursor material disposed over a sheet-shaped continuous workpiece to form a solar cell absorber, the apparatus comprising: a process gap defined by a peripheral wall, wherein the sheet-shaped continuous workpiece travels between an entry opening and an exit opening of the of the process gap, wherein within the process gap a reaction process is used to form the solar cell absorber from the precursor material on the sheet-shaped continuous workpiece; an unwind port sealably attached to the entry opening of the process gap, wherein the unwind port includes an unwind chamber with a supply roll disposed therein from which the sheet-shaped continuous workpiece is advanced into the process gap through the entrance opening; a rewind port sealably attached to the exit opening of the process gap, wherein the rewind port includes a rewind chamber with a receiving roll disposed therein that receives and wraps therearound the sheet-shaped continuous workpiece from the process gap through the exit opening; and a first moisture removal unit that operates in conjunction with the unwind port and includes: a moisture desorption device to remove moisture from the sheet-shaped continuous workpiece as the sheet-shaped continuous workpiece is unwound from the supply roll disposed within the unwind chamber, wherein the moisture removed from the sheet-shaped continuous workpiece is contained within the unwind chamber, and a moisture absorption device to remove the moisture that is contained within the unwind chamber from the unwind chamber.

In another preferred aspect is provided an exhaust system to remove Group VIA material vapors from a reactor used to process precursor layers to form Group IBIIIAVIA compound thin films for solar cells, the reactor including an exhaust outlet, the exhaust system comprising: a first material collector unit, including a collector, adapted to connect to the exhaust outlet of the reactor through a first connector line to receive a first exhaust gas flow from the reactor, wherein the first exhaust gas flow includes at least one Group VIA material vapor and a carrier gas, and wherein the first connector line is maintained at a second temperature that is lower than a first temperature of the exhaust outlet so that a first amount of the Group VIA material carried by the first exhaust gas flow liquefies and flows into the collector thereby forming a first precipitate of the Group VIA material within the first material collector unit; a second material collector unit, including a condenser, connected to the first material collector unit through a second connector line to receive a second exhaust gas flow from the first material collector, wherein a second amount of the Group VIA material carried by the second exhaust gas flow is condensed by the condenser maintained at a third temperature that is lower than the second temperature so as to form a second precipitate within the second material collector unit, and wherein the second amount of the Group VIA material is less than the first amount of the Group VIA material; a third material collector unit, including a filter, connected to the second material collector unit through a third connector line to receive a third exhaust gas flow from the second material collector, and wherein a third amount of the Group VIA material carried by the third exhaust gas flow is filtered by the filter so as to collect a third precipitate in the filter, and wherein the third amount of the Group VIA material is less than the second amount of the Group VIA material; and wherein a fourth exhaust gas flow leaves the third material collector through a fourth connector line, and wherein the fourth exhaust gas flow is the carrier gas that is substantially free of the Group VIA material.

### BRIEF DESCRIPTION OF THE DRAWINGS

FIG. 1 is a cross-sectional view of a solar cell employing a Group IBIIIAVIA absorber layer;

FIG. 2 shows an apparatus to react precursor layers in a reel-to-reel fashion to form a Group IBIIIAVIA layer on a flexible foil base;

FIG. 3A shows an exemplary flexible structure including a flexible base and a precursor layer deposited on it;

FIG. 3B shows a base with a Group IBIIIAVIA absorber layer formed on it by reacting the precursor layer(s) of FIG. 3A;

FIG. 4 shows another apparatus to react precursor layers in a reel-to-reel fashion to form a Group IBIIIAVIA layer on a flexible foil base;

FIGS. 5A-5B show cross-sectional views of different reaction chambers with a flexible structure placed in them;

FIG. 5C shows a cross-sectional view of a reaction chamber including an outer chamber and an inner chamber;

FIG. 6 shows such an exemplary version of the reactor of FIG. 2;

FIG. 7A is a schematic illustration of an embodiment of a rapid thermal processing (RTP) tool of the present invention including a buffer zone connecting a cold zone to a hot zone;

FIG. 7B is a graph depicting a thermal profile of the RTP tool shown in FIG. 7A;

FIG. 8A is a schematic illustration of an embodiment of a roll to roll rapid thermal processing system of the present invention including an embodiment of an RTP tool;

FIG. 8B is a schematic perspective view illustration of the RTP tool shown in FIG. 8A, wherein the RTP tool includes more than one buffer zone;

FIG. 9 is a schematic illustration of another embodiment of an RTP tool of the present invention;

FIG. 10A is a schematic illustration of another embodiment of an RTP tool of the present invention;

FIG. 10B is a graph depicting a thermal profile applied by a top section of the RTP tool shown in FIG. 10A;

FIG. 10C is a graph depicting a thermal profile applied by a bottom section of the RTP tool shown in FIG. 10A;

FIG. 11A is a schematic side view of an embodiment of a reactor including peripheral reactor walls and an insert placed into the primary gap defined by the peripheral reactor walls;

FIG. 11B is a schematic frontal view of the reactor shown in FIG. 11A;

FIG. 11C is a schematic frontal view of the peripheral reactor walls;

FIG. 11D is a schematic frontal view of the insert;

FIG. 11E is a schematic frontal view of the reactor shown in FIG. 11B, wherein the continuous insert has been set on a bottom wall of the peripheral reactor walls;

FIG. 12A is a schematic side view of another embodiment of the reactor shown in FIG. 11A, wherein a bottom wall of an insert includes rollers on which a continuous workpiece is moved;

FIG. 12B is a schematic frontal view of the reactor shown in FIG. 12A;

FIG. 12C is a schematic partial view of the rollers shown in FIG. 12A;

FIG. 13 is a schematic side view of an embodiment of a reactor;

FIG. 14A is a schematic cross sectional side view of another embodiment of a reactor with upper rollers;

FIG. 14B is a schematic cross sectional front view of the reactor shown in FIG. 14A;

FIG. 14C is a schematic detailed view of a portion of the reactor in FIG. 14A, including an isolation roller according to a preferred embodiment;

FIG. 15 is a schematic view of an embodiment of a multi-exhaust reactor;

FIG. 16 is a schematic view of an embodiment of a reactor;

FIG. 17A is a schematic view of an embodiment of a reactor with sealed rewind port;

FIG. 17B is a schematic view of an embodiment of a reactor with sealed unwind port;

FIG. 18 is a partial schematic view of an embodiment of a reactor with an unwind port;

FIG. 19 is a schematic view of an embodiment of a reactor;

FIG. 20 is a schematic view of an embodiment of a reactor;

FIG. 20A is a schematic view of a section of a reactor near the entrance opening of the process gap;

FIG. 21 is a schematic illustration of an embodiment of an exhaust gas cleaning system of the present invention;

FIG. 22 is schematic illustration of another embodiment of an exhaust gas cleaning system of the present invention;

FIG. 23 is a flow chart showing an embodiment of an exhaust gas cleaning process steps of the present invention;

FIG. 24 is a schematic perspective view of a roll of an unprocessed workpiece;

FIG. 25 is a roll to roll system including a single moisture removal station; and

FIG. 26 is a roll to roll system including two moisture removal stations.

### DETAILED DESCRIPTION OF THE PREFERRED EMBODIMENTS

Reaction of precursors, comprising Group IB material(s), Group IIIA material(s) and optionally Group VIA material(s) or components, with Group VIA material(s) may be achieved in various ways. These techniques involve heating the precursor layer to a temperature range of 350-600° C., preferably to a range of 400-575° C., in the presence of at least one of Se, S, and Te provided by at least one of the sources such as; i) solid Se, S or Te sources directly deposited on the precursor, and ii) H₂Se gas, H₂S gas, H₂Te gas, Se vapors, S vapors, Te vapors etc. for periods ranging from 1 minute to several hours. The Se, S, Te vapors may be generated by heating solid sources of these materials away from the precursor also. Hydride gases such as H₂Se and H₂S may be bottled gases. Such hydride gases and short-lifetime gases such as H₂Te may also be generated in-situ, for example by electrolysis in aqueous acidic solutions of cathodes comprising S, Se and/or Te, and then provided to the reactors. Electrochemical methods to generate these hydride gases are suited for in-situ generation.

Precursor layers may be exposed to more than one Group VIA materials either simultaneously or sequentially. For example, a precursor layer comprising Cu, In, Ga, and Se may be annealed in presence of S to form Cu(In,Ga)(S,Se)₂. The precursor layer in this case may be a stacked layer comprising a metallic layer containing Cu, Ga and In and a Se layer that is deposited over the metallic layer. Alternately, Se nano-particles may be dispersed throughout the metallic layer containing Cu, In and Ga. It is also possible that the precursor layer comprises Cu, In, Ga and S and during reaction this layer is annealed in presence of Se to form a Cu(In,Ga)(S,Se)₂.

Some of the preferred embodiments of forming a Cu(In,Ga)(S,Se)₂ compound layer may be summarized as follows: i) depositing a layer of Se on a metallic precursor comprising Cu, In and Ga forming a structure and reacting the structure in gaseous S source at elevated temperature, ii) depositing a mixed layer of S and Se or a layer of S and a layer of Se on a metallic precursor comprising Cu, In and Ga forming a structure, and reacting the structure at elevated temperature in either a gaseous atmosphere free from S or Se, or in a gaseous atmosphere comprising at least one of S and Se, iii) depositing a layer of S on a metallic precursor comprising Cu, In and Ga forming a structure and reacting the structure in gaseous Se source at elevated temperature, iv) depositing a layer of Se on a metallic precursor comprising Cu, In and Ga forming a structure, and reacting the structure at elevated temperature to form a Cu(In,Ga)Se₂ layer and/or a mixed phase layer comprising selenides of Cu, In, and Ga and then reacting the Cu(In,Ga)Se₂ layer and/or the mixed phase layer with a gaseous source of S, liquid source of S or a solid source of S such as a layer of S, v) depositing a layer of S on a metallic precursor comprising Cu, In and Ga forming a structure, and reacting the structure at elevated temperature to form a Cu(In,Ga)S₂ layer and/or a mixed phase layer comprising sulfides of Cu, In, and Ga, and then reacting the Cu(In,Ga)S₂ layer and/or the mixed phase layer with a gaseous source of Se, liquid source of Se or a solid source of Se such as a layer of Se.

It should be noted that the Group VIA materials are corrosive. Therefore, materials for all parts of the reactors or chambers that are exposed to Group VIA materials or material vapors at elevated temperatures should be properly selected. These parts should be made of or should be coated by substantially inert materials such as ceramics, e.g. alumina, tantalum oxide, titanium oxide or titania, zirconium oxide or zirconia, etc., glass, quartz, certain types of stainless steel, graphite, refractory metals such as Ta, refractory metal nitrides and/or carbides such as Ta-nitride and/or carbide, Ti-nitride and/or carbide, W-nitride and/or carbide, other nitrides and/or carbides such as Si-nitride and/or carbide, etc.

Reaction of precursor layers comprising Cu, In, Ga and optionally at least one Group VIA material may be carried out in a reactor that applies a process temperature to the precursor layer at a low rate. Alternately, rapid thermal processing (RTP) may be used where the temperature of the precursor is raised to the high reaction temperature at rates that are at least about 10° C./sec. The Group VIA material, if included in the precursor layer, may be obtained by techniques such as evaporation, sputtering and electroplating. Alternately inks comprising Group VIA nano particles may be prepared and these inks may be deposited to form a Group VIA material layer within the precursor layer. Other liquids or solutions such as organometallic solutions comprising at least one Group VIA material may also be used. Dipping into melt or ink, spraying the melt or ink, doctor-blading or ink writing techniques may also be employed to deposit such layers.

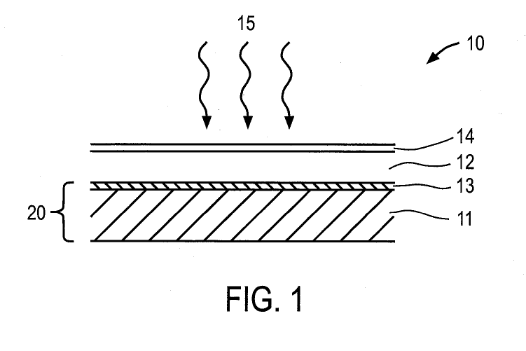

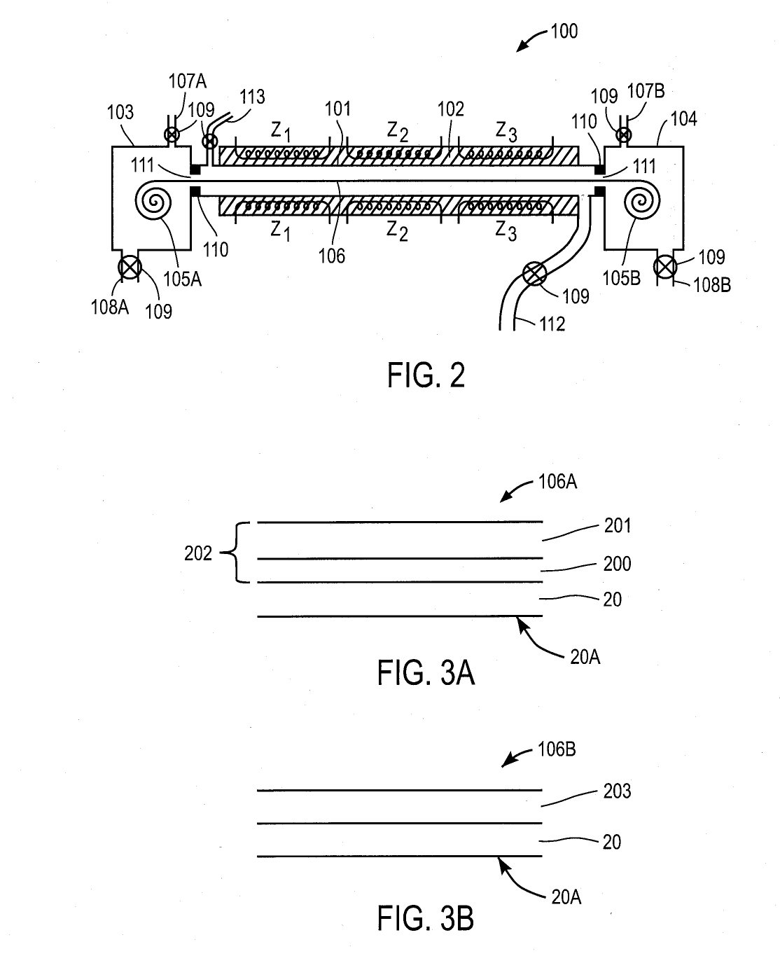

A reel-to-reel apparatus 100 or roll to roll RTP reactor to carry out reaction of a precursor layer to form a Group IBIIIAVIA compound film is shown in FIG. 2. It should be noted that the precursor layer to be reacted in this reactor may comprise at least one Group IB material and at least one Group IIIA material. For example the precursor layer may be a stack of Cu/In/Ga, Cu—Ga/In, Cu—In/Ga, Cu/In—Ga, Cu—Ga/Cu—In, Cu—Ga/Cu—In/Ga, Cu/Cu—In/Ga, or Cu—Ga/In/In—Ga, etc., where the order of various material layers within the stack may be changed. Here Cu—Ga, Cu—In, In—Ga, Cu—In—Ga mean alloys or mixtures of Cu and Ga, alloys or mixtures of Cu and In, and alloys or mixtures of In and Ga, and alloys or mixtures of Cu, In and Ga , respectively. Alternatively, the precursor layer may also include at least one Group VIA material. There are many examples of such precursor layers. Some of these are Cu/In/Ga/Group VIA material stack, Cu-Group VIA material/In/Ga stack, In-Group VIA material/Cu-Group VIA material stack, or Ga-Group VIA material/Cu/In stack, where Cu-Group VIA material includes alloys, mixtures or compounds of Cu and a Group VIA material (such as Cu-selenides, Cu sulfides, etc.), In-Group VIA material includes alloys, mixtures or compounds of In and a Group VIA material (such as In-selenides, In sulfides, etc.), and Ga-Group VIA material includes alloys, mixtures or compounds of Ga and a Group VIA material (such as Ga-selenides, Ga sulfides, etc.). These precursors are deposited on a base 20 comprising a substrate 11, which may additionally comprise a conductive layer 13 or contact layer as shown in FIG. 1. Other types of precursors that may be processed using the method and apparatus of the embodiments described herein include Group IBIIIAVIA material layers that may be formed on a base using low temperature approaches such as compound electroplating, electroless plating, sputtering from compound targets, ink deposition using Group IBIIIAVIA nano-particle or metallic nano-particle based inks, spraying metallic nanoparticles comprising Cu, In, Ga and optionally Se, etc. These material layers are then annealed in the apparatus or reactors at temperatures in the 350-600° C. range to improve their crystalline quality, composition and density.

Annealing and/or reaction steps may be carried out in the reactors of the present invention at substantially the atmospheric pressure, at a pressure lower than the atmospheric pressure or at a pressure higher than the atmospheric pressure. Lower pressures in reactors may be achieved through use of vacuum pumps.

The reel-to-reel apparatus 100 of FIG. 2 may comprise an elongated heating chamber 101 that is surrounded by a heater system 102 which may have one or more heating zones such as Z1, Z2, and Z3 to form a temperature profile along the length of the chamber 101. In between zones there are preferably buffer regions of low thermal conductivity so that a sharp temperature profile may be obtained. Details of such use of buffer regions are discussed in U.S. application Ser. No. 11/549,590 entitled Method and Apparatus for Converting Precursor layers into Photovoltaic Absorbers, filed on Oct. 13, 2006, which is incorporated herein by reference. The chamber 101 is integrally sealably attached to a first port 103 and a second port 104. Integrally sealably means that the internal volume of the chamber 101, the first port 103 and the second port 104 are sealed from air atmosphere, therefore, any gases used in the internal volume do not leak out (except at designated exhaust ports) and air does not leak into the internal volume. In other words, the integration of the chamber 101, the first and the second ports are gas and vacuum tight. A first spool 105A and a second spool 105B are placed in the first port 103 and the second port 104, respectively, and a continuous flexible workpiece 106 or flexible structure can be moved between the first spool 105A and the second spool 105B in either direction, i.e. from left to right or from right to left. The flexible structure includes a precursor layer to be transformed into an absorber layer in the elongated heating chamber 101. The first port 103 has at least one first port gas inlet 107A and a first port vacuum line 108A. Similarly, the second port 104 has at least one second port gas inlet 107B and may have a second port vacuum line 108B. The elongated heating chamber 101 as well as the first port 103 and the second port 104 may be evacuated through either or both of the first port vacuum line 108A and the second port vacuum line 108B. The chamber 101 is also provided with at least one gas line 113 and at least one exhaust 112. There may be additional vacuum line(s) (not shown) connected to the chamber 101. Valves 109 are preferably provided on all gas inlets, gas lines, vacuum lines and exhausts so that a common chamber is formed that can be placed under a single vacuum. There are preferably slits 110 at the two ends of the chamber 101, through which the flexible structure 106 passes through. Although, evacuation of the chamber and the first and second ports is the preferred method to get rid of air from the internal volume of the tool, purging the internal volume of the tool with a gas such as N₂ through designated exhaust port(s) is also possible.

The flexible structure 106A before the reaction may be a base with a precursor film deposited on at least one face of the base. The flexible structure 106B after the reaction comprises the base and a Group IBIIIAVIA compound layer formed as a result of reaction of the precursor layer. It should be noted that we do not distinguish between the reacted and unreacted sections of the flexible structure 106 in FIG. 2, calling both the flexible structure 106. We also refer to the flexible structure as a “web” irrespective of whether the precursor layer over it is reacted or unreacted. The substrate of the base may be a flexible metal or polymeric foil. As described above, the precursor film on the base comprises at least Cu, In, and Ga and optionally a Group VIA material such as Se. The back side 20A of the flexible structure 106 may or may not touch a wall of the chamber 101 as it is moved through the chamber 101. The process of the present invention will now be described through specific examples.

### EXAMPLE 1

A Cu(In,Ga)(Se,S)₂ absorber layer may be formed using the single chamber reactor design of FIG. 2. An exemplary flexible structure 106A before the reaction is shown in FIG. 3A. The base 20 may be similar to the base 20 of FIG. 1. A precursor layer 200 is provided on the base 20. The precursor layer 200 comprises Cu, and at least one of In and Ga. Preferably the precursor layer 200 comprises all of Cu, In and Ga. A Se layer 201 may optionally be deposited over the precursor layer 200 forming a Se-bearing precursor layer 202. Se may also be mixed in with the precursor layer 200 (not shown) forming another version of a Se-bearing precursor layer. The flexible structure after the reaction step is shown in FIG. 3B. In this case the flexible structure 106B after the reaction comprises the base 20 and the Group IBIIIAVIA compound layer 203 such as a Cu(In,Ga)(Se,S)₂ film that is obtained by reacting the precursor layer 200 or the Se-bearing precursor layer 202.

After loading the unreacted flexible structure 106A or web on, for example, the first spool 105A, one end of the web may be fed through the chamber 101, passing through the gaps 111 of the slits 110, and then wound on the second spool 105B. Doors (not shown) to the first port 103 and the second port 104 are closed and the system (including the first port 103, the second port 104 and the chamber 101) is evacuated to eliminate air. Alternately the system may be purged through the exhaust 112 with an inert gas such as N₂ coming through any or all of the gas inlets or gas lines for a period of time. After evacuating or purging, the system is filled with the inert gas and the heater system 102 may be turned on to establish a temperature profile along the length of the chamber 101. When the desired temperature profile is established, the reactor is ready for process.

During the process of forming, for example, a Cu(In,Ga)Se₂ absorber layer, a gas comprising Se vapor or a source of Se such as H₂Se may be introduced into the chamber, preferably through chamber gas inlet 113. The exhaust 112 may now be opened by opening its valve so that Se bearing gas can be directed to a scrubber or trap (not shown). It should be noted that Se is a volatile material and at around the typical reaction temperatures of 400-600° C. its vapor tends to go on any cold surface present and deposit in the form of solid or liquid Se. This means that, unless precautions are taken during the reaction process, Se vapors may pass into the first port 103 and/or the second port 104 and deposit on all the surfaces there including the unreacted portion of the web in the first port 103 and the already reacted portion of the web in the second port 104. To minimize or eliminate such Se deposition, it is preferable to introduce a gas into the first port 103 through the first port gas inlet 107A and introduce a gas into the second port 104 through the second port gas inlet 107B. The introduced gas may be a Se-bearing and/or S-bearing gas that does not breakdown into Se and/or S at low temperature, but preferably the introduced gas is an inert gas such as N₂ and it pressurizes the two ports establishing a flow of inert gas from the ports towards the chamber 101 through the gaps 111 of the slits 110. The velocity of this gas flow can be made high by reducing the gaps 111 of the slits 110 and/or increasing the flow rate of the gas into the ports. This way diffusion of Se vapor into the ports is reduced or prevented, directing such vapors to the exhaust 112 where it can be trapped away from the processed web. The preferred values for the gap 111 of the slits 110 may be in the range of 0.5-5 mm, more preferably in the range of 1-3 mm. Flow rate of the gas into the ports may be adjusted depending on the width of the slits which in turn depends on the width of the flexible structure 106 or web. Typical web widths may be in the range of 1-4 ft.

Once the Se-bearing gas and inert gas flows are set and the desired temperature profile of the chamber 101 is reached, the flexible structure 106 may be moved from the first port 103 to the second port 104 at a pre-determined speed. This way, an unreacted portion of the flexible structure 106 comes off the first roll 105A, enters the chamber 101, passes through the chamber 101, gets reacted forming a Cu(In,Ga)Se₂ absorber layer on the base of the web and gets rolled onto the second spool 105B in the second port 104. It should be noted that there may be an optional cooling zone (not shown) within the second port 104 to cool the reacted web before winding it on the second spool 105B.

The above discussion is also applicable to the formation of absorber layers containing S. For example, to form a Cu(In,Ga)S₂ layer the Se-bearing gas of the above discussion may be replaced with an S-bearing gas such as H₂S. To form a Cu(In,Ga)(Se,S)₂, a mixture of Se-bearing gas and S-bearing gas may be used. Alternately, a Se-bearing precursor may be utilized and reaction may be carried out in an S-bearing gas.

One feature of the system 100 of FIG. 2 is that the flexible structure 106 may be moved from left to right as well as from right to left. This way more than one reaction step may be carried out. For example, a first reaction may be carried out as the web is moved from left to right, then a second reaction may be carried out as the web is moved from right to left and the reacted web may be unloaded from the first spool 105A. Of course, even more steps of reaction or annealing etc., may be carried out by moving the web more times between the first spool 105A and the second spool 105B. Reaction conditions, such as gas flow rates and the reaction temperature may be different for the various reaction steps. For example, the temperature profile of the chamber 101 may be set to a maximum temperature of 400° C. for the first reaction step when the web is moved from left to right. This way the precursor of the web may be partially or fully reacted or annealed at 400° C. After substantially all portions of the web is rolled on the second spool 105B, the maximum temperature of the temperature profile may be adjusted to a higher value, such as to 550° C., and the web may be moved from right to left as the already annealed or reacted precursor layer may be further reacted, annealed or crystallized, this time at the higher temperature of 550° C. It should be noted that a similar process may be achieved by making the chamber 101 longer and setting a temperature profile along the chamber 101 such that as the web travels from left to right, for example, it travels through a zone at 400° C. and then through a zone at 550° C. However, using bi-directional motion as described above, the length of the chamber 101 may be reduced and still the two step/two temperature reaction may be achieved. To keep the temperature of the web high when it is rolled onto either one of the first spool 105A or the second spool 105B in between reaction steps, there may be optional heaters (not shown) placed in either or both of the first port 103 and the second port 104.

It should be noted that in addition to the reactor temperature and the web speed, the reaction gas composition may also be changed in the multi-step reaction approach described above. For example, during the first reaction step when the web is moved from left to right a first gas such as H₂Se may be used in the chamber 101 to form a selenized precursor layer. During the second reaction step when the web is moved from right to left, on the other hand, another gas such as H₂S may be introduced in the chamber 101. As a result, the selenized precursor layer may be reacted with S as the web is moved from the second spool 105B to the first spool 105A and thus a Cu(In,Ga)(Se,S)₂ layer may be grown by converting the already selenized precursor layer into sulfo-selenide. By selecting the gas concentrations, web speeds and reaction temperatures, the amount of Se and S in the absorber layer may be controlled. For example, S/(Se+S) molar ratio in the final absorber layer may be increased by increasing the web speed and/or reducing the reaction temperature during the first process step when reaction with Se is carried out. Similarly, the S/(Se+S) molar ratio may also be increased by reducing the web speed and/or increasing the reaction temperature during the second step of reaction where reaction with S is carried out. This provides a large degree of flexibility to optimize the absorber layer composition by optimizing the two reaction steps independent from each other.

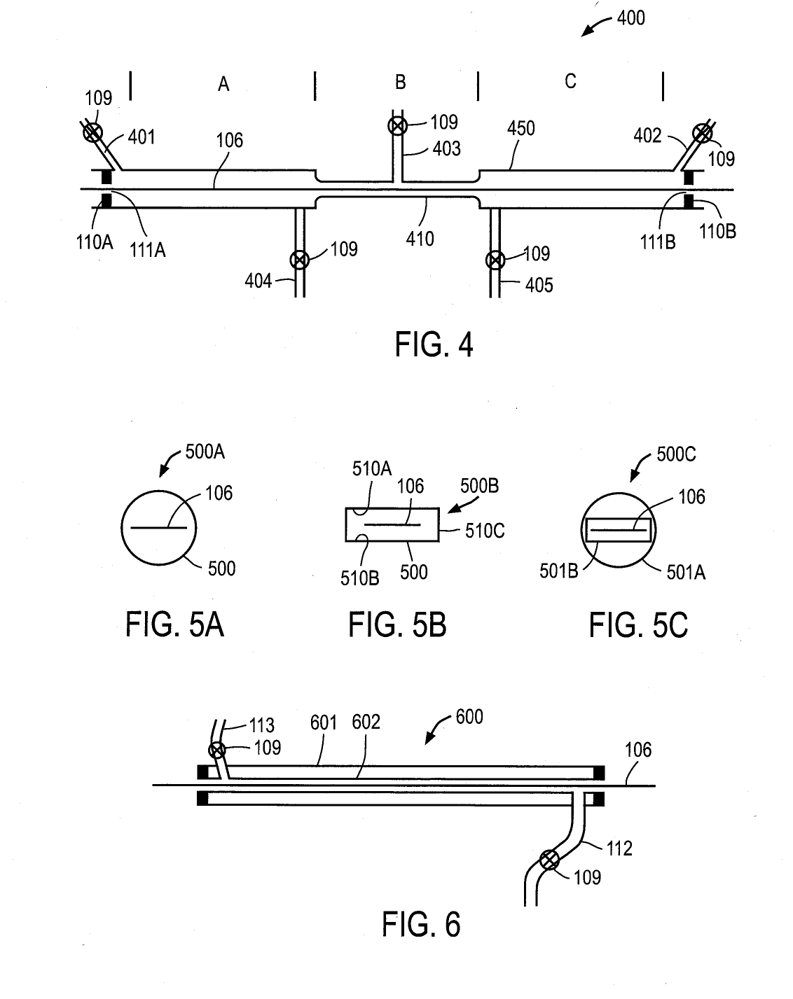

Another embodiment of the present invention is shown in FIG. 4. The reactor system 400 in FIG. 4 comprises a three-section chamber 450 which is an example of a more general multi-chamber design. The three-section chamber 450 of FIG. 4 comprises sections A, B and C. Heaters around each section as well as the first port, the first spool, the second port and the second spool are not shown in this figure to simplify the drawing. However, designs similar to those shown in FIG. 2 may be used for such missing parts. The heating means may be heat lamps, heater coils etc. and they may have independent controls to yield different temperature values and profiles in the sections of A, B and C.

One important feature of the design of FIG. 4 is that sections A and C are separated by a segment, preferably a low-volume segment 410 which is within section B of the three-section chamber 450. There are lines to bring gas into each of the sections A, B and C. For example, inlets 401 and 402 may bring gas into sections A and C, respectively, whereas inlet 403 may bring gas into the low-volume segment 410 in section B. Exhausts 404 and 405 may be provided to exhaust gases from sections A and C, respectively. A flexible structure 106 to be processed or reacted may pass through a first gap 111A of a first slit 110A, enter the three-section chamber 450 and then exit through the second gap 111B of a second slit 110B.

### EXAMPLE 2

A Cu(In,Ga)(Se,S)₂ absorber layer may be formed using the three-section chamber reactor of FIG. 4. After loading the unreacted flexible structure 106, pumping and purging the system as described in Example 1, the process may be initiated. Sections A, B and C of the three-section chamber 450 may have temperatures of T1, T2 and T3 which may or not be equal to each other. Furthermore, each of the sections A, B and C may have a temperature profile rather than just a constant temperature along their respective lengths. During processing, a first process gas such as N₂ may be introduced into the low-volume segment 410 in section B through inlet 403, while a second process gas and a third process gas may be introduced in sections A and C, respectively, through inlets 401 and 402, respectively.

The second process gas and the third process gas may be the same gas or two different gases. For example, the second process gas may comprise Se and the third process gas may comprise S. This way when a portion on the flexible structure 106 enters the section A of the three-section chamber 450 through the first gap 111A of the first slit 110A, the precursor layer on the portion starts reacting with Se forming a selenized precursor layer on the portion. When portion enters the low-volume segment 410, it gets annealed in the N₂ gas (if section B is heated) within this segment until it enters section C. In section C sulfidation or sulfurization takes place due to presence of gaseous S species, and a Cu(In,Ga)(Se,S)₂ absorber layer is thus formed on the portion before the portion exits the three-section chamber 450 through the second gap 111B of the second slit 110B. The S/(Se+S) molar ratio in the absorber layer may be controlled by the relative temperatures and lengths of the sections A and C. For example, at a given web speed the S/(Se+S) ratio may be increased by decreasing the length and/or reducing the temperature of section A. Alternately, or in addition, the length and/or the temperature of section C may be increased. Reverse may be done to reduce the S/(Se+S) molar ratio. It should be noted that, as in the previous example, it is possible to run the flexible structure or web backwards from right to left to continue reactions. It is also possible to change the gases introduced in each section A, B and C of the three-section chamber 450 to obtain absorber layers with different composition. The design of FIG. 4 has a unique feature of allowing two different gases or vapors to be present in two different sections of the reactor so that reel-to-reel continuous processing may be done on a web substrate by applying different reaction temperatures and different reaction gases in a sequential manner to each portion of the web. Introducing an inert gas to a reduced volume segment in between the two sections (sections A and C in FIG. 4) acts as a diffusion barrier and minimizes or eliminates intermixing between the different gases utilized in those two sections. The first gas introduced through inlet 403 in FIG. 4 flows through the low-volume segment 410 to the right and to the left opposing any gas flows from sections A and C towards each other. It should be noted that more sections may be added to the reactor design of FIG. 4 with more low-volume segments between them and each section may run with different temperature and gas to provide process flexibility for the formation of high quality Group IBIIIAVIA compound absorber layers. Also more gas inlets and/or exhaust may be added to the system of FIG. 4 and locations of these gas inlets and exhaust . may be changed.

A variety of different cross sectional shapes may be used for the chambers of the present invention. Two such chambers 500A and 500B having circular and rectangular cross sections, respectively, are shown in FIGS. 5A and 5B. Substantially cylindrical reaction chambers with circular cross section are good for pulling vacuum in the chamber even if the chamber is made from a material such as glass or quartz. The circular chambers however, get very large as the substrate or web width increases to 1 ft, 2 ft or beyond. Temperature profiles with sharp temperature changes cannot be sustained using such large cylindrical chambers and thus roll-to-roll RTP process cannot be carried out on wide flexible substrates such as substrates that may be 1-4 ft wide or even wider.

As shown in FIG. 5B, the chamber 500B includes a rectangular gap defined by the top wall 510A, bottom wall 510B, and the side walls 510C. In this case the chamber is preferably constructed of metal because for pulling vacuum in such a chamber without breaking it requires very thick walls (half an inch and larger) if the chamber is constructed of quartz or glass. In this configuration, the top wall 510A and the bottom wall 510B are substantially parallel to each other, and the flexible structure 106 is placed between them. Chambers with rectangular cross section or configuration is better for reducing reactive gas consumption since the height of such chambers may be reduced to below 10 mm, the width being approximately close to the width of the flexible structure (which may be 1-4 ft). Such small height also allows reaction in Group VIA vapor without the need to introduce too much Group VIA material into the chamber. It should be noted that the height of the chamber 500B, i.e., gap size, is the distance between the top and the bottom walls and small gap size is necessary to keep a high overpressure of Group VIA material over the surface of the precursor layer during reaction. Also these chambers can hold sharply changing temperature profiles even for flexible substrate widths beyond 4 ft. For example, a temperature profile along the length of a chamber with a rectangular cross-section may comprise a temperature change of 400-500° C. within a distance of a few centimeters. Such chambers, therefore, may be used in roll-to-roll RTP mode wherein a section of a precursor film on a substrate traveling at a speed of a few centimeters per second through the above mentioned temperature change experiences a temperature rise rate of 400-500° C./sec. Even higher rates of a few thousand degrees Centigrade per second may be achieved by increasing the speed of the substrate.

As shown in cross sectional view in FIG. 5C, another preferred chamber design includes a dual chamber 500C where an inner chamber 501B with rectangular cross section is placed within a cylindrical outer chamber 501A with circular cross section. In this case the flexible structure 106 or web passes through the inner chamber 501B which may be orthorhombic in shape and all the gas flows are preferably directed to and through the inner chamber 501B which has a much smaller volume than the outer chamber 501A. This way waste of reaction gases is minimized but at the same time the whole chamber may be easily evacuated because of the cylindrical shape of the outer chamber 501B, even though the chamber may be made out of a material such as quartz. Heaters (not shown) in this case may be placed outside the inner chamber 501B, but inside the outer chamber 501A. This way sharp temperature profiles can be sustained along the length of the rectangular cross section chamber while having the capability to evacuate the reactor body.

FIG. 6 shows such an exemplary version of the reactor of FIG. 2. Only the chamber portion is shown for simplifying the drawing. As can be seen from this figure, the dual-chamber 600 comprises a cylindrical chamber 601 and an orthorhombic chamber 602 which is placed in the cylindrical chamber 601. Gas inlet 113 and exhaust 112 are connected to the orthorhombic chamber 602. It should be noted that the cylindrical chamber 601 may not be hermetically sealed from the orthorhombic chamber so that when the overall chamber is pumped down, pressure equilibrates between the cylindrical chamber 601 and the orthorhombic chamber. Otherwise, if these chambers are sealed from each other, they may have to be pumped down together at the same time so that there is not a large pressure differential between them.

In the following, various embodiments of roll-to-roll or reel-to-reel RTP tools will be provided. The RTP tool of the present invention may have at least one cold zone, at least one hot zone and a buffer zone connecting these two zones. The zones in this embodiment are formed along a process gap of the RTP tool. A workpiece is processed in the process gap while it is moved in a process direction. It is understood that the terms “hot” or “warm” or “high temperature” zone and “cold” or “cool” or “low temperature” zone are intended as being conditionally relative, such that the hot/warm/high temperature zone is warmer than the cold/cool/low temperature zone, though the degree of differential does not require a maximum low temperature for the cold zone or a minimum high temperature for the hot zone.

In one embodiment, the zones are preferably placed along the process gap and form a section surrounding a portion of the process gap so that when a portion of the workpiece is advanced through a specific zone, that portion of the workpiece is treated with the thermal conditions that are assigned to that zone. In accordance with the principles of the present invention, buffer zones may be formed as part of a processing gap of the RTP tool and connect two zones which are kept in different temperatures. In this respect, a buffer zone may connect a lower temperature zone to a higher temperature zone, or a higher temperature zone to a lower temperature zone. For example, the low temperature zone may be kept at a first temperature so that a portion of a continuous workpiece is subjected to the first temperature as the portion of the continuous workpiece travels through the low temperature zone. The high temperature zone, on the other hand, may be kept at a second temperature so that the portion of the continuous workpiece is subjected to the second temperature when it travels through the high temperature zone. If the buffer zone connects the lower temperature zone to the higher temperature zone and if the portion of the continuous workpiece is made to travel from the lower temperature zone to the higher temperature zone, the temperature of the portion of the continuous workpiece is increased from the first temperature to the second temperature as it travels through the buffer zone. This, in effect, provides conditions of rapid thermal processing to the portion of the continuous workpiece. The continuous workpiece is moved at a predetermined speed through the buffer zone from the low temperature to high temperature zones of the thermal processing tool zone such that the rate of heating experienced by a portion of the continuous workpiece as it travels through the buffer zone can be easily made 10° C./second or much higher (such as 100-500° C./sec) by selecting the values for the low temperature, the high temperature, the speed of the continuous workpiece and the length of the buffer zone. In a particular embodiment, the buffer zone is less than 10% of the length of the high temperature zone, and in a preferred embodiment the length of the buffer zone is in the range of 1-5% of the length of the high temperature zone. In preferred embodiments, the specific length of the first buffer zone is less than 10 cm, and preferably less than 5 cm. This flexibility and the ability to reach very high temperature rates at low cost, keeping the processing throughputs very high are unique features of the present design.

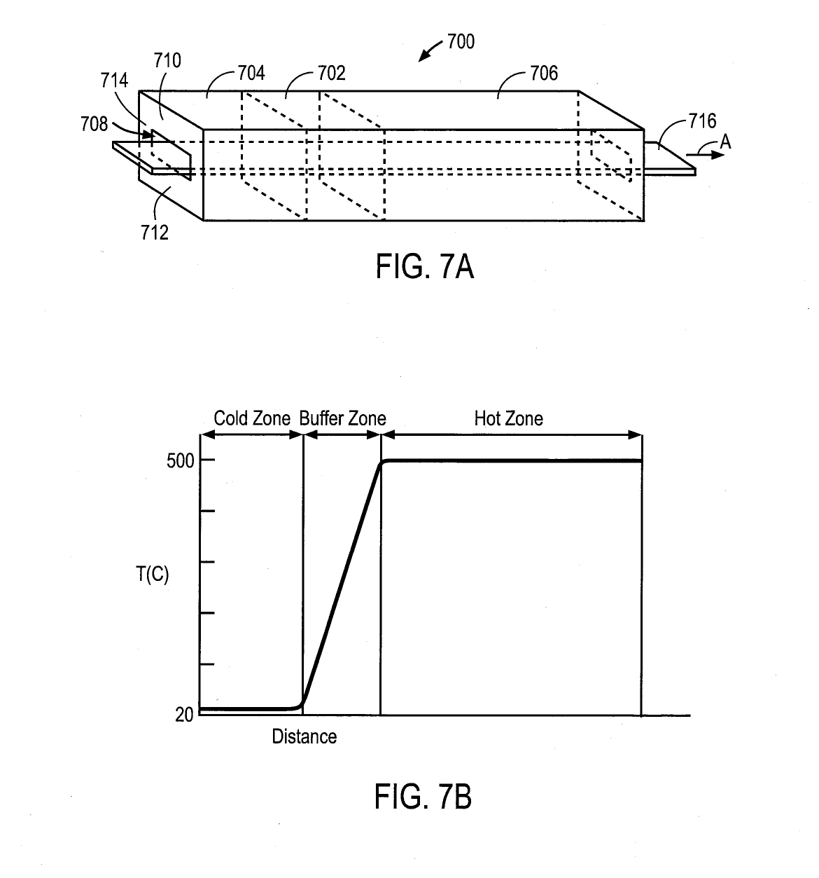

FIG. 7A shows a section of an exemplary rapid thermal processing system 700 having a buffer zone 702 connecting a low temperature zone 704 such as a cold zone to a high temperature zone 706 or a hot zone. The system 700 may be a part of a larger system including more zones. For example, the hot zone 706 may be followed by another buffer zone and cold zone combination. Furthermore, the hot zone may be divided by one or more buffer zones to establish a desired temperature profile within the hot zone, each heated zone having a different temperature. A process gap 708 of the system is defined by a top wall 710, a bottom wall 712 and side walls 714. The process gap 708 extends through the cold zone 704, the buffer zone 702, and the hot zone 706. In each zone, the top wall, the bottom wall, and side walls may be made of the same material or different materials, and using different construction features. The gap height and width may be varied along the process gap in each zone. The process gap is preferably in the range of 2 mm-20 mm height and 10-200 cm width. An aspect ratio for the gap may be between 1:50 and 1:2500. The aspect ratio is defined herein as the ratio between height (or depth) of the gap and its smallest lateral dimension (width). The height of the process gap may be increased to larger values such as up to about 50 mm if the speed of the continuous workpiece is increased, and therefore the length of the buffer zone may also be increased still keeping the temperature rise rates at or above 10° C./sec.

A continuous workpiece 716 is moved with a predetermined speed in the process gap 708 during the process, in the direction depicted by arrow A. In this embodiment, a cooling system (not shown) may be used to maintain low temperature in cold zone 704, and a heating system (not shown) is used to maintain high temperature in the hot zone 706. As will be described more fully below, the buffer zone 702 is a low thermal conductivity zone connecting the cold zone to hot zone so that both zones are maintained in their set temperature ranges without any change by using a short buffer zone. It should be noted that the shorter the buffer zone is, the higher the temperature rise rate can be experienced by a portion of a workpiece moving at a constant speed through the buffer zone. In that respect, the present invention achieves buffer zone lengths in the range of 2-15 cm, making it possible to keep one end of the buffer zone at room temperature (about 20° C.) and the other end at a high temperature in the range of 500-600° C. The low thermal conductivity characteristics of the buffer zone may be provided by constructing at least one of the top wall, bottom wall and optionally side wall of the buffer zone, or at least a portion of them with low thermal conductivity materials and/or features. As shown in FIG. 7B, in an exemplary temperature profile for the system 700, the low thermal conductivity characteristics of the buffer zone of the system 700 steps up the temperature of the continuous workpiece, in a sharp manner, from a colder to a hotter temperature. This way as the workpiece is moved from a cold zone to a hot zone it experiences a temperature rise rate determined by its speed. The temperature of the cold zone may be less than 50° C., preferably 20-25° C., and temperature of the hot zone may be 300-600° C., preferably 500-550° C. If the length of the buffer zone is 10 cm, and if the continuous workpiece is moved at a speed of lcm/second, the rate of heating of the workpiece in the buffer zone will be about (550-20)/10=53° C./sec in this example. A temperature controller, not shown, can be used to control the heating of the cold zone and the hot zone. This approximation of temperature rise is valid as long as heat conduction to the substrate in the hot and cold zone is not a limiting factor.

As shown in FIG. 7A, each zone comprises and surrounds a predetermined portion of the process gap 708, and the workpiece portion in them is exposed to the exemplary thermal profile shown in FIG. 7B. Within this context, ‘portion’ of the continuous workpiece may be defined as a rectangular portion of the workpiece having a length, width and thickness, wherein the width and the thickness are the width and the thickness of the continuous flexible workpiece. For example, if a portion of the continuous flexible workpiece is in the hot zone, substantially that entire portion of the continuous workpiece material is exposed to the temperature of the hot zone. The same is true for the cold and buffer zones. The portion of the continuous workpiece in these zones will be exposed to the conditions of these zones.

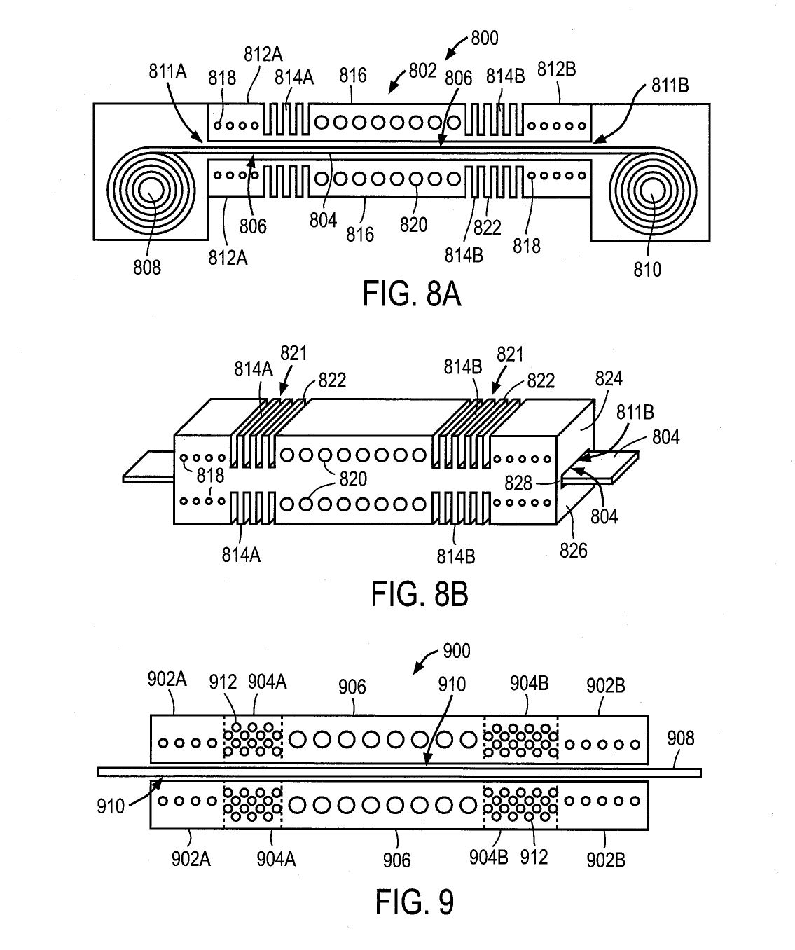

FIG. 8A shows a cross-sectional side view of a roll to roll processing system 800 including an embodiment of a RTP tool 802 to process a flexible continuous workpiece 804 (workpiece hereinafter). The workpiece 804 is extended along a process gap 806 of the RTP tool 802, and between a supply spool 808 and a receiving spool 810. FIG. 8B illustrates the RTP tool in side-perspective view. Referring to FIGS. 8A and 8B, the process gap 806 extends between an entry opening 811A and an exit opening 811B, and is defined by a top wall 824, a bottom wall 826 and side walls 828. A moving mechanism (not shown) unwraps and feeds the workpiece 804 into the process gap 806, and takes up and wraps the workpiece 804 around the receiving spool 810 when it leaves the process gap 806. It should be noted that one important feature of the present design is its leak-free construction. Air and/or oxygen are, preferably, not allowed to enter the process gap. This requires the process gap to be preferably constructed in a leak-free manner and vacuum can be pulled in the process gap to eliminate air before the RTP process is initiated, preferably after filling back the process gap with an inert gas or a reactive gas such as a gas comprising Se and or S.

In this embodiment, the RTP tool includes a first cold zone 812A, a first buffer zone 814A, a hot zone 816, a second buffer zone 814B, and a second cold zone 812B. Accordingly, the first buffer zone 814A facilitates heating of the workpiece 804, and the second buffer zone 814B cooling of the workpiece 804. The second buffer zone 814B connects the hot zone, which is kept in a high temperature, to the cold zone, which is kept in a lower temperature. In this embodiment, in order to cause a slower rate of cooling, the second buffer zone 814B may be longer than the first buffer zone 814A, which may be kept short to facilitate rapid heating of the workpiece. A cooling system with cooling members 818 cools the cold zones 812A and 812B. An exemplary cooling system may be a cooling system using a fluid coolant such as a gas or liquid coolant. The hot zone 816 includes a series of heating members 820 placed along the hot zone 816. Heating members each may be controlled separately or in groups through use of temperature controllers and thermocouples placed near the heating members in each zone. In that respect it is possible to separate the hot zone in multiple heated zones with one or more heaters that are controlled separately. In this embodiment, the buffer zones 814A and 814B include low thermal conductivity features 821 to reduce flow of heat from the hot zone towards the cold zones.

Details of the buffer zones will be described using FIG. 8B which shows the buffer zones 814A and 814B of the RTP tool 802 in more detail. Thermal conductivity of at least a portion of the buffer zone 814A may be lowered by forming cavities within the walls of the buffer zone without negatively impacting the mechanical integrity of the walls. This is important since, as explained before, the process gap needs to be leak-free. The cavities may extend perpendicular to the lateral axis of the process gap by forming grooves in the walls. Alternatively, as described in another embodiment below (see FIG. 9), the cavities may be through cavities (or holes) formed through the width of the top wall or bottom wall portions and height of the side walls. By cutting grooves into or onto the top and bottom walls, the cross sectional area of the wall material (which may be, for example, stainless steel) interconnecting the hot and cold zones is reduced. This way thermal conduction through this cut region is reduced. In this embodiment, both the top wall and the bottom wall of the buffer zones include an equal number of cuts placed in a symmetrical manner. To form the buffer zone, the cuts on the top and the bottom extend along the same portion of the process gap 806. Although in this embodiment, side walls 828A may not include any of the features 821, it is possible to have features on the side walls as well. The cuts in the top and bottom walls may each have a width of 1 mm or greater. Their depth may be about 50-80% of the thickness of the top wall or the bottom wall. It should be noted that use of this design with cuts yield the desirable near-linear temperature change going from a hot zone to a cold zone or vice-versa as shown in FIG. 7B. In one embodiment, the hot zone and the buffer zone may be enclosed in a thermal insulator to avoid heat loss from the reactor. Alternately, the RTP tool 802 may be fully covered by an insulating enclosure to protect users from high temperature and to reduce heat loss.

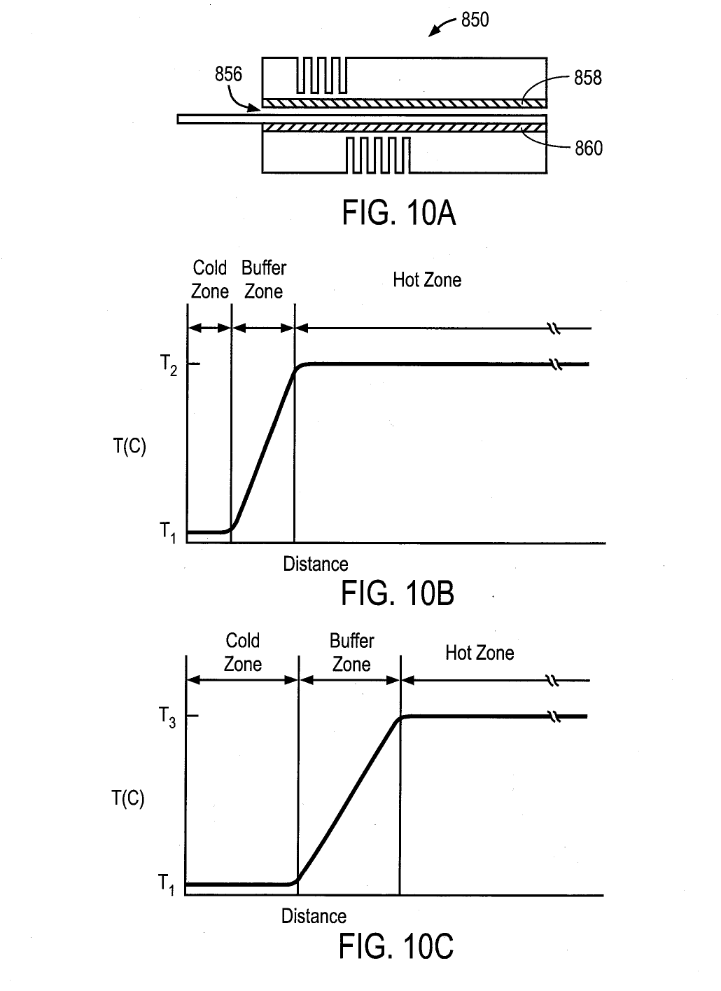

FIG. 9 shows another embodiment of an RTP tool 900 having cold zones 902A and 9002B, buffer zones 904A and 904B, and hot zone 906. A continuous workpiece 908 is extended through a process gap 910 of the tool 900. Design of cold and hot zones are the same as the RTP tool 802 described in the previous embodiment. In this embodiment, low thermal conductivity features in the buffer zones may be holes 912 which are drilled within the walls of the buffer zones 904A and 904B. Presence of the holes 912 reduces the cross sectional area of the metallic wall material conducting the heat from the hot zone to the cold zones, replacing this material with air. It should be noted that in FIGS. 7A and 8A, the workpiece is shown in the middle of the process gap. However, depending on the position of the process gap (horizontal, vertical or at an angle) one face of the workpiece may actually touch at least one of the walls defining the process gap. In FIG. 10A we show a situation where the bottom of the workpiece touches the bottom wall.

FIG. 10A shows a RTP tool 850 in side partial view. The RTP tool 850 is an alternative embodiment of the RTP tool 802 shown in FIGS. 8A and 8B. In this embodiment, different thermal profiles are established at the upper and lower walls of the process gap by having buffer regions associated with the top and bottom walls that are disposed between hot regions and cold regions, such that the top buffer region is not necessarily co-extensive with the bottom buffer region, and in fact the bottom buffer region may overlap either or both of the top cold region and the top hot region, and vice versa. For example, the temperature profile of the upper wall may be as shown in FIG. 10B and the temperature profile of the lower wall may be as shown in FIG. 10C. The benefit of this design is the fact that the workpiece may be thermally coupled to one of the walls (lower wall in FIG. 10A) and therefore experiences substantially the thermal profile of that wall (FIG. 10C), whereas the opposite wall of the reaction chamber may be at a different temperature (FIG. 10B). By keeping the top wall hot region hotter than a bottom wall cold region disposed directly below it, for example, it is possible to thermally activate the gaseous species (such as Se vapors or H₂Se vapors etc.) which may be present in the process gap while controlling the temperature of the workpiece itself by the bottom wall hot region. Having a top hot wall region across from the workpiece surface also keeps reactive species in vapor phase by not letting them condense and possibly drip down on the workpiece surface. For example, by maintaining a top hot wall region, Se condensation may be avoided during a RTP process that uses Se species to selenize precursors comprising Cu, In and Ga. Different temperature profiles at different regions of the top and bottom walls of the process gap may also be obtained by using upper wall insert 858 and lower wall insert 860 which may have different designs and thermal conductivities. For example, if an upper wall insert 858 is well thermally coupled to a hot region but poorly thermally coupled to a cold region, then it is possible to move the high temperatures closer to the inlet 856 along the upper wall insert 858.

In the following embodiments the roll-to-roll or reel-to-reel thermal processing or RTP tools include a reactor having an insert placed in a primary gap of the reactor. The primary gap of the reactor is defined by peripheral reactor walls including a top reactor wall, a bottom reactor wall and side reactor walls as will be further described below. The insert includes a secondary gap, also called process gap hereinafter, through which a continuous workpiece travels between an entry opening and an exit opening of the insert. The process gap is defined by insert walls including a top insert wall, a bottom insert wall and side insert walls. This process gap height and width may be varied along the process gap, and there can be separate zones as described above. The process gap, within the insert is preferably in the range of 2 mm-20 mm height and 10-200 cm width. An aspect ratio (height to width ratio) for the process gap may be between 1:50 and 1:2500. Such inserts, as well as the web valves and rollers that will be discussed later, may be used in any of the previously discussed reactors of FIGS. 2, 4, 6, 7A, 8A and 8B.

In one embodiment an inner space exists between at least one of the insert walls and at least a portion of the peripheral reactor walls. The width of the inner space or the distance between the at least one of the insert walls and the portion of the peripheral reactor walls may be in the range of 2-20 mm, preferably 3-5 mm. At least one gas inlet is connected to the inner space, and at least one exhaust opening connects the process gap as well as the inner space to outside and carries any gaseous products to outside the process gap and the primary gap of the reactor. Sealable doors or web valves may seal the entrance and the exit of the process gap when needed before or after the process, especially when the continuous workpiece stops moving. As the continuous workpiece with a precursor material film such as a precursor layer comprising Cu, In, Ga and Se, is continuously fed into the process gap and treated with heat and process gases (such as an inert gas, a selenium containing gas and/or a sulfur containing gas), a flushing gas such as nitrogen is delivered to the inner space through the gas inlets. Then the flushing gas, the process gas, and any other gaseous species that may be created in the process gap as a result of the heat treatment of the precursor layer within the process gap, are exhausted through the exhaust opening. During the process, at the beginning of the process or at the end of the process, movement of the continuous workpiece may be halted and the entrance and the exit doors may be sealed. In one embodiment, the bottom insert wall may include rollers on which the continuous workpiece may be moved without damaging its back surface.

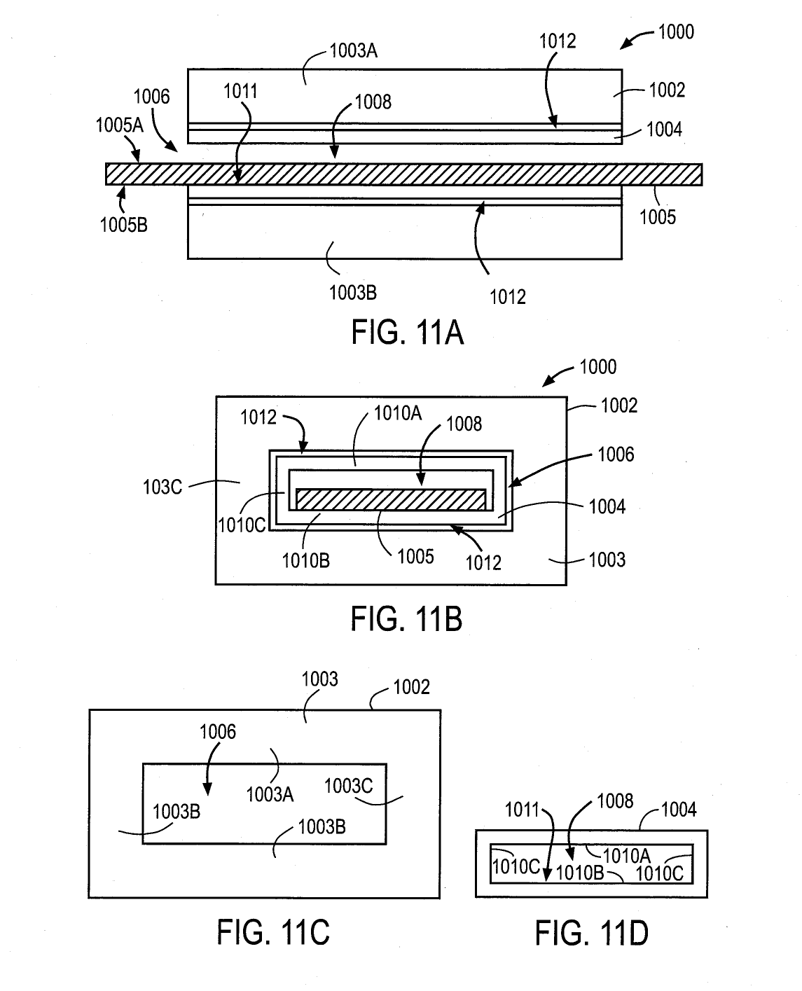

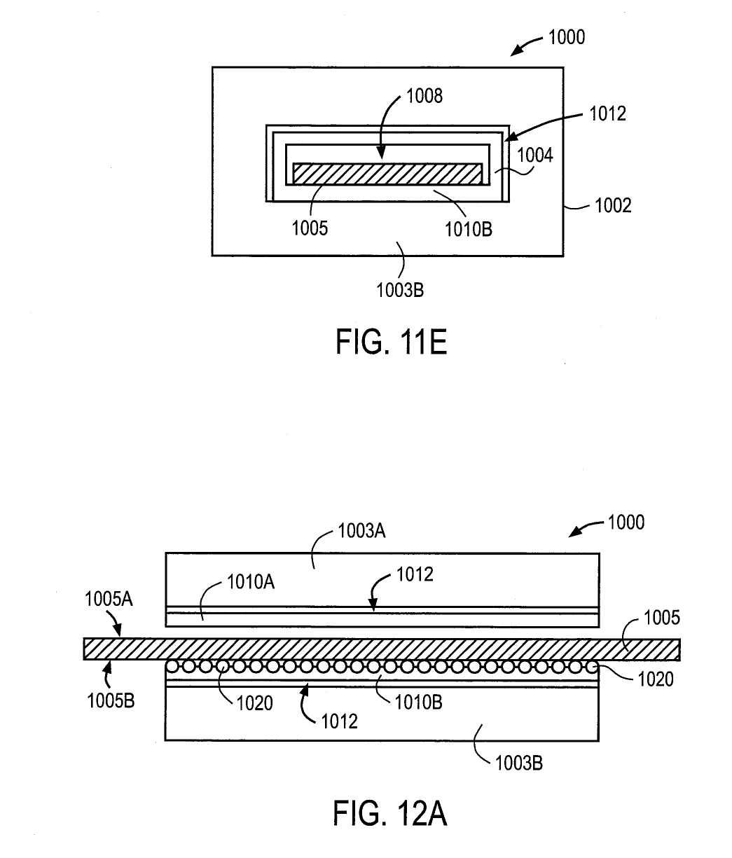

FIG. 11A shows in side view a continuous reactor 1000 including peripheral reactor walls 1002 and an insert 1004 placed into the primary gap defined by the peripheral reactor walls 1002. The insert 1004 is made of materials that are chemically stable at high temperatures (in the 400-600° C. range) in presence of Group VIA materials, especially Se and S. These materials include, but are not limited to quartz, graphite and ceramics such as alumina, zirconia, and alumina+silica, alumina+zirconia, alumina+titania composites, etc. The peripheral reactor walls 1002 are made of heat stable materials that keep their mechanical integrity up to temperatures in the range of 700-900° C. range. It is preferred that these materials are suitable, i.e. has the strength, for forming a vacuum environment within the primary gap. Such materials include, but are not limited to, various stainless steels such as 304 and 316 series stainless steels. A continuous workpiece 1005 having a front surface 1005A and a back surface 1005B is extended through a process gap 1008 of the insert 1004. The front surface 1005A of the continuous workpiece includes a precursor material such as a precursor layer comprising Cu, In, Ga and optionally Se. FIG. 11B shows the reactor 1000 in cross sectional front view, and FIGS. 11C and 11D show the peripheral reactor walls 1002 and the insert 1004 of the reactor in cross sectional front view. As shown in FIG. 11C, the peripheral reactor walls 1002 include a top reactor wall 1003A, a bottom reactor wall 1003B and side reactor walls 1003C, which altogether define a primary gap 1006. The peripheral reactor walls 1002 may include the heating elements described above. As shown in FIG. 11D, the insert 1004 includes a process gap 1008 defined by an insert top wall 1010A, an insert bottom wall 1010B and insert side walls 1010C.

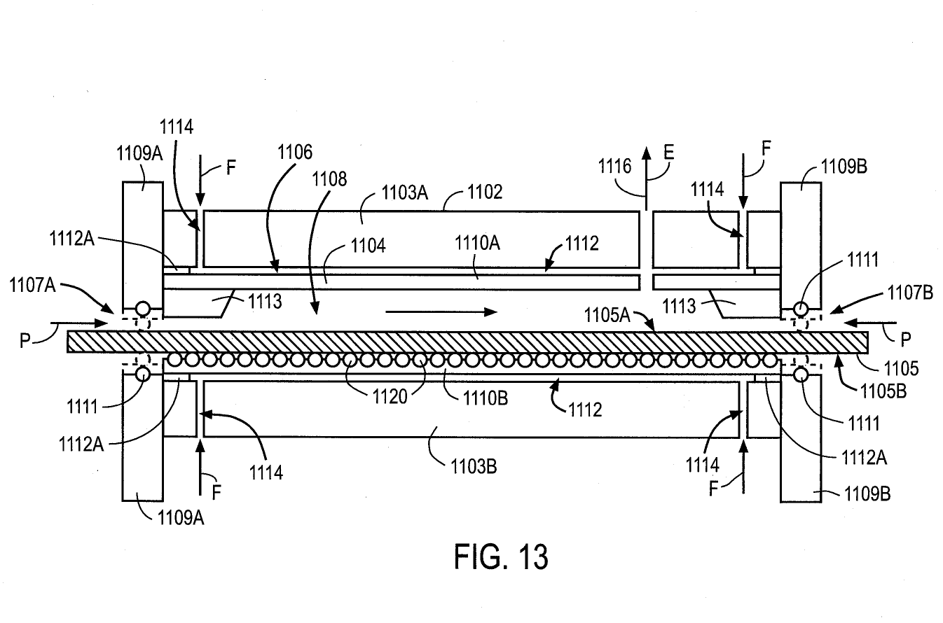

As shown in FIGS. 11A and 11B the insert 1004 is placed into the primary gap 1006 of the reactor defined by the peripheral reactor walls 1002 while leaving an inner space 1012 between the peripheral reactor walls 1002 and the insert 1004. The inner space 1012 may be maintained by placing spacers (not shown), preferably made from ceramics, graphite or stainless steel between the peripheral reactor walls 1002 and at least one of the walls of the insert 1004. The inner space 1012 enables both the peripheral reactor walls 1002 and the insert 1004 to expand or contract without giving structural damage to one another. In this embodiment, the peripheral reactor walls 1002 may include heaters (not shown) which may be located within the walls or outside the walls. The heaters heat the peripheral reactor walls 1002, which in turn heat the primary gap 1006, the insert 1004 and that portion of the continuous work piece 1005 within the process gap 1008 of the insert 1004. As discussed before, the peripheral reactor walls 1002 may be made of a metal such as stainless steel which may react with the selenium and/or sulfur vapors present in the process gap 1008 at temperatures at or over 500° C., if such vapors find a pathway into the primary gap 1006 at high concentrations, and are in physical contact with the peripheral reactor walls 1002. In order to prevent such reactive process gasses from leaking into the inner space, a flushing gas such as nitrogen (N₂) may be delivered into the inner space 1012. Such flushing gas may establish a blanket of flowing inert gas (such as nitrogen) within the inner space 1012 and does not allow high concentration of selenium and sulfur species to enter the inner space and corrode the inner surfaces of the peripheral reactor walls 1002. The flushing gas may be preheated before being directed into the inner space 1012 through at least one gas inlet (see for example gas inlets 1114 in FIG. 13) to avoid excessive heat loss from the reactor. The continuous workpiece 1005 to be processed is extended through the process gap 1008 and moved while the back surface 1005B is in physical contact with a surface 1011 of the bottom wall 1010B of the insert 1004.

FIG. 11E shows another embodiment where the insert 1004 is set on the bottom wall 1003B of the peripheral reactor walls 1002. In this embodiment, inner space 1012 is established between the respective top and side walls of the insert 1004 and the peripheral reactor walls 1002 as in the manner shown in FIG. 11E.

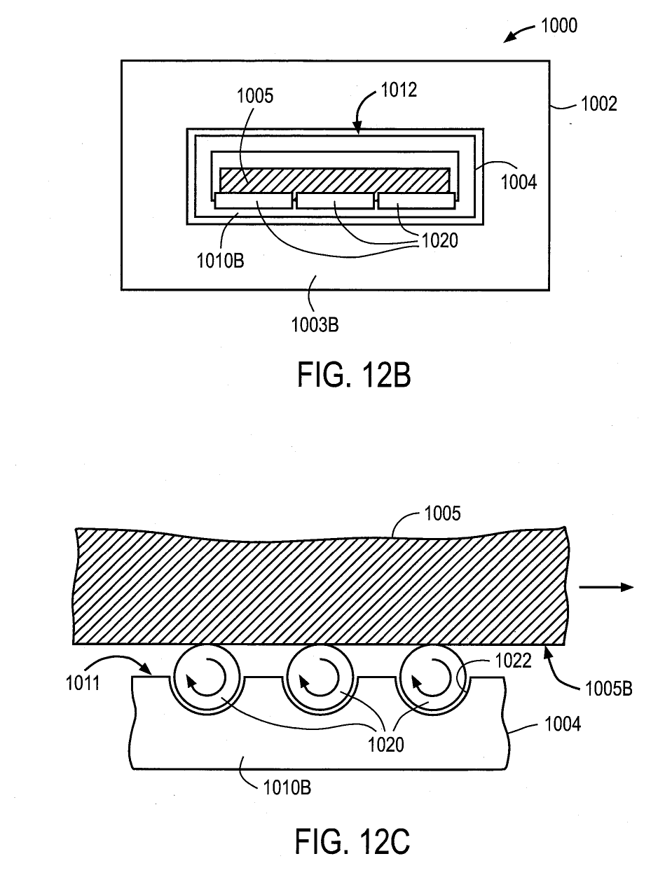

As shown in FIGS. 12A and 12B, bottom wall 1010B of the insert 1004 may include a low friction surface such as rollers 1020 on which the continuous workpiece 1005 is moved without causing excessive friction between the back surface 1005B and the bottom wall 1010B. Balls or ball bearings may also be used in place of or in addition to rollers. This embodiment is especially useful if the back surface 1005B is coated with a protective layer that protects the substrate from the effects of corrosive process gasses such as selenium and sulfur. If the back surface 1005B is moved while resting against a high friction surface of the bottom wall 1010B of the insert 1004, such protective layers (such as a molybdenum layer, a chromium layer, a metal nitride layer, etc.) may get scratched and damaged exposing portions of the substrate, which may comprise aluminum or steel, to corrosive environment. Resulting corrosion of the back surface 1005B generates reaction products in the form of particles and debris which fall into the process gap 1008, reduce up time of the reactor between cleaning steps, and reduce yield of the process by generating defects in solar cells due to the particles. The design shown in FIG. 12A resolves this problem. Since the back surface 1005B is rolled on the rollers 1020, the back surface 1005B is protected against damage and scratching. As shown in FIG. 12C, the rollers 1020 are movably placed into roller cavities 1022 formed in the surface 1011 of the bottom wall 1010B. They may be attached to ceramic bearings at the two ends, near the side walls 1010C of the insert 1004, so that they can freely rotate in the cavities 1022. The rollers can be fabricated from inert materials that do not react with selenium and sulfur at high temperatures. Such materials include, but are not limited to graphite, quartz, alumina, zirconia, etc. To prevent sliding of the continuous workpiece 1005 on the rollers 1020, the rollers are of low inertia and are sufficiently spaced. The diameter of the rollers 1020 may range from 3 mm to about 10 mm. In one embodiment, the rollers 1020 are made of alumina and are spaced at intervals ranging from 200 mm to about 600 mm. Generally, the spacing increases for lighter continuous workpieces and with higher workpiece tensions.

FIG. 13 shows a reactor embodiment 1100 including peripheral walls 1102 and an insert 1104 which is placed into the primary gap 1106 defined by the peripheral walls 1102 as described above. The primary gap 1106 is defined by a top wall 1103A, a bottom wall 1103B and side walls (not shown in this figure) of the peripheral walls 1102. A continuous workpiece 1105 having a front surface 1105A and a back surface 1105B is extended through a process gap 1108 of the insert 1104 between an entrance opening 1107A or entrance and an exit opening 1107B or exit. The continuous workpiece 1105 is, as in the other embodiments, a portion of a continuous workpiece roll which may be 500-1000 meters long. As described above, in roll to roll systems, the continuous workpiece is typically fed into the reactor from a supply spool and received, after the processing, from the reactor by a receiving spool. The process gap 1108 is defined by an insert top wall 1110A, an insert bottom wall 1110B, and insert side walls (not shown in this figure). The entrance 1107A and the exit 1107B may include a sealable entrance door 1109A and a sealable exit door 1109B. The sealable entrance and exit doors 1109A and 1109B may be slit valves or web valves. The sealable entrance and exit doors 1109A, 1109B include sealing members 1111 which contact the front and optionally the back surfaces of the workpiece 1105 when the sealable doors are in a sealing position. In FIG. 13 the sealable entrance and exit doors 1109A, 1109B are shown in open position or a first position in which the sealing members are away from the front surface 1105A and the back surface 1105B of the workpiece 1105. As depicted with dotted lines, when the sealable entrance and exit doors 1109A, 1109B are moved into the sealing position or a second position, the sealing members 1111 contact the front and back surfaces of the workpiece 1105.

An inner space 1112 is established between the peripheral walls 1102 and the insert 1104. Plugs 1112A are placed near the entrance 1107A and exit 1107B. Gas inlet lines 1114 provided through the peripheral walls 1102 to allow a flushing gas, depicted by arrows ‘F’, to flow into the inner space 1112. An exhaust opening 1116 is placed between the entrance 1107A and the exit 1107B, and runs through the peripheral walls 1102 and the insert 1104 to remove the exhaust gas, depicted by the arrow ‘E’, from the reactor 1100. The bottom wall 1110B of the insert 1104 may have rollers 1120 on which the continuous workpiece 1105 is moved.

During the process, the flushing gas F is flowed into the gas inlets 1114 and thereby into the inner space 1112. The gas is unable to escape near the entrance 1107A and exit 1107B because of the presence of the plugs 1112A, and it is directed towards the exhaust 1116. Process gases, depicted by the arrows ‘E’, which may be inert gases, are fed through the entrance opening 1107A and the exit opening 1107B into the process gap 1108 of the insert 1104, as a moving mechanism (not shown) moves a portion of the continuous workpiece 1105 into the process gap 1106 for reaction. The process gases P provide a barrier against discharge of selenium and sulfur vapors present in the process gap 1108 to outside of the process gap through the entrance and exit. The established process gas flow urges such vapor species to move over the top surface of the continuous workpiece 1105 towards the exhaust 1116 where they mix with the flush gas and removed as the exhaust gas E into a trap that condenses them safely. Flowing process gas moves the reactive species (such as Se and/or S) along with the continuous workpiece, keeping these species over the reacting precursor layer. This way residence time of the reacting species over the precursor layer is increased enhancing the reaction between the precursor layer the reactive species, and thus enhancing overall utilization of the volatile reactive species. For example, in batch RTP processes employed to form CIGS layers using a precursor layer comprising Cu, In, Ga and Se; an amount of selenium that is 20-100% more than what is necessary for the formation of CIGS is included in the precursor layer because these reactors loose much of the volatile Se species during the reaction process. In the present design, the volatile Se species, after they evaporate out of the precursor layer, stay over the precursor layer on other parts of the continuous workpiece and eventually get utilized. Therefore, in the roll-to-roll process of the present invention, precursor layers comprising Cu, In, Ga and Se may be prepared to have no excess Se or only up to about 10% excess Se. This is considerable savings over the prior art approaches that required 20-100% excess Se in the precursor layers. It should be noted that if the Se amount in the reactor is not adequate, the CIGS films formed under Se deficient conditions do not yield high efficiency solar cells because they typically contain low resistivity Cu-Se binary phases. During the process, the sealable doors 1109A and 1109B are kept in the open position to let the process gases P in through the entrance 1107A and the exit 1107B. However, as will be described more fully below during the processes intervals, the sealable doors 1109A and 1109B are moved into closed position or a second position, as shown with dotted lines, to seal the entrance 1107A and the exit 1107B by pressing the seal members 1111 onto the front surface 1105A and the back surface 1105B of the continuous workpiece 1105. It should be noted that the seal members against the back surface 1105B of the continuous workpiece 1105 may or may not be employed, i.e. only the top seal members may be used and the back surface of the workpiece may be supported by a flat surface.

As mentioned above, the continuous workpiece 1105 may be supplied from a supply spool adjacent the entrance opening 1107A and received by a receiving spool adjacent the exit opening 1107B of the reactor 1100. The supply spool and the receiving spool may be kept in a supply chamber (similar to the first port 103 of FIG. 2) and a receiving chamber (similar to the second port 104 of FIG. 2) respectively, which may be sealably connected to the reactor 1100. Examples of supply and receiving chambers containing supply and receiving spools are shown in FIGS. 2 and 8A. Further, high vacuum pumps may be added to remove air from the supply and receiving chambers as well as the process gap, therefore eliminating excess oxygen which is very harmful for the formation of high quality CIGS layers. Vacuum pumps that are capable of removing water vapor at high speeds are preferred, because higher speeds will speed up the evacuation of the supply and receiving chambers and therefore decrease the idle time of the reactor. Removing air and impurities from the supply and receiving chambers reduces the likelihood of their incorporation into the absorber film that is processed and thus enhances the quality of the absorber film such as a CIGS type absorber film. It should be noted that even trace amounts (a few parts per million) of oxygen causes oxidation of Cu, In and Ga and lower the photovoltaic quality of CIGS. Pumping the system down to vacuum levels better than 10⁻⁵ Ton and therefore eliminating oxygen before the initiation of the reactions between Cu, In, Ga, Se and/or S is very important for the quality of the resulting CIGS layer.

There are advantages in using the reactor 1100 equipped with the sealable doors 1109A and 1109B of the present invention together with the above described vacuum sealed supply and receiving chambers to process a roll of the continuous workpiece 1105.

In one exemplary process, when processing of an entire roll of the continuous workpiece 1105 in the reactor 1100, which may be 500-1000 meters long, is almost completed in the reactor 1100, the process is halted while still a portion of the continuous workpiece 1105, which may be 2-4 meters, is still wrapped around the supply spool. Next, the sealable doors 1109A and 1109B seal the entrance opening 1107A and the exit opening 1107B by moving into the sealing position. As described above, in the sealing position, the seal members 1111 of the sealable doors 1109A, 1109B contact the front surface 1105A and the back surface 1105B of the workpiece 1105 to seal the entrance and exit openings. Once the reactor 1100 is sealed in this manner, the supply chamber is opened to atmosphere and a roll of a new continuous workpiece is loaded into the supply chamber and connected to the portion of the continuous workpiece that extends to the receiving spool. During this time, the process gap is protected from air by the sealable doors. After the supply chamber is resealed, pumped down and the sealable doors 1107A and 1107B are moved into open position, the continuous workpiece 1105 is fully advanced into the receiving chamber while pulling a leading end of the new continuous workpiece into the receiving chamber. In the following step, sealable doors are once again brought into the sealing position but this time on the front and back surfaces of the new continuous workpiece; and then the receiving chamber is unsealed and opened to detach the processed workpiece from the leading end of the new continuous workpiece and to remove the processed roll of the workpiece 1105 from the receiving chamber. Next, the leading end of the new workpiece is attached to the receiving spool; the receiving chamber is sealed and pumped down; and the sealable doors 1109A and 1109B are moved into the open position to start processing the new workpiece in the reactor 1100. Benefits of sealing the reactor in this manner especially during the workpiece loading unloading intervals are generally three fold: (1) sealing speeds up the loading a new workpiece roll and unloading the processed one; (2) sealing keeps the process gap of the reactor clean and free of oxidizing species at such intervals; and (3) sealing reduces the amount of Se in the exhaust traps since the complete removal of Se from the reactor is not required, which further enhances the utilization of Se and reduces the amount of cleaning and maintenance of the traps.

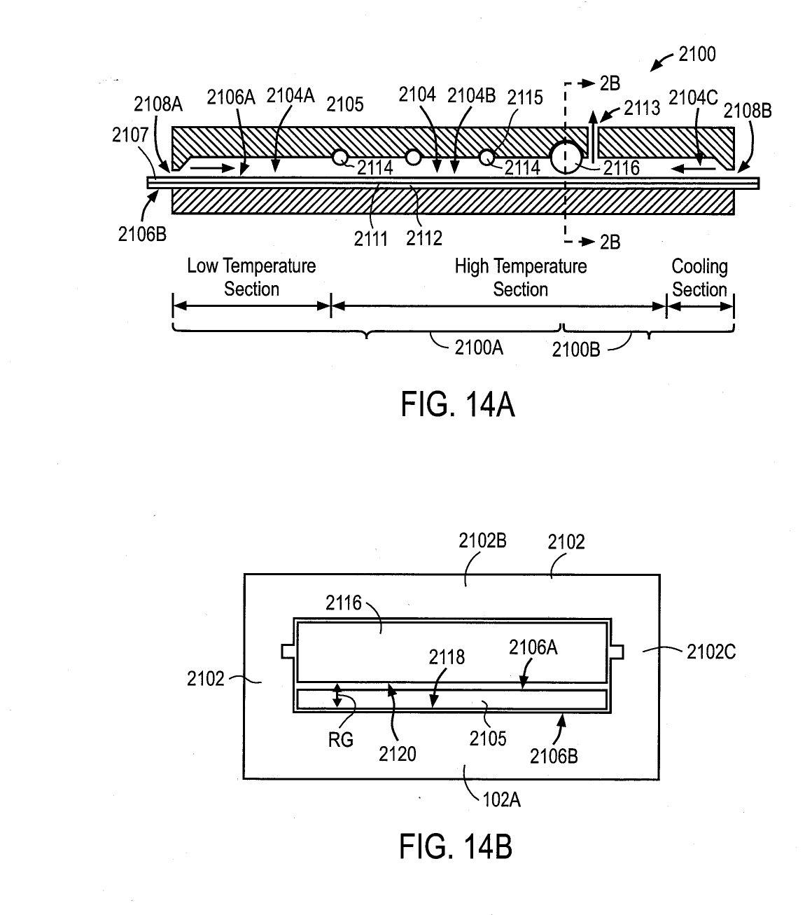

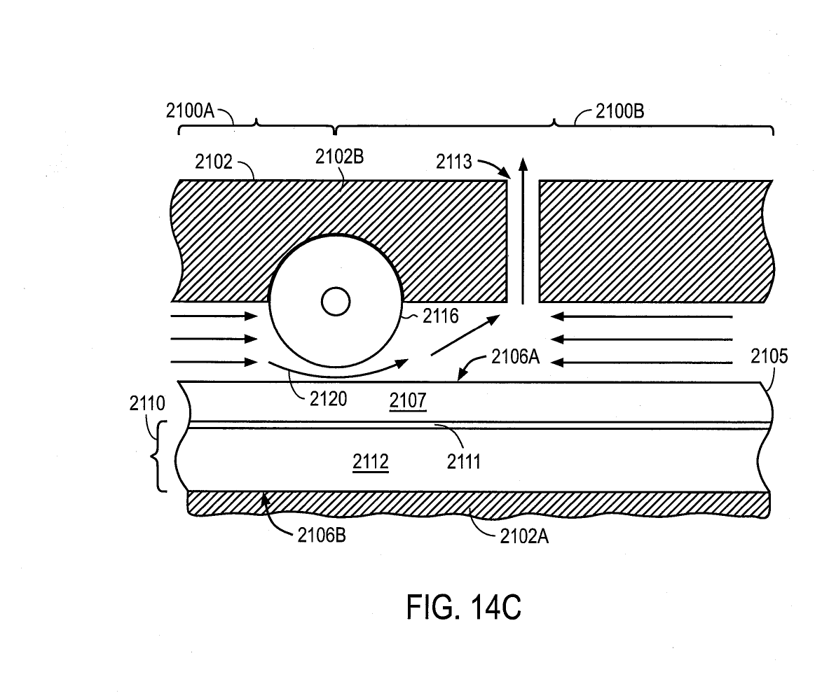

Other embodiments of reel-to-reel, or roll to roll apparatus to carry out reaction of a precursor layer on a flexible workpiece to form a Group IBIIIAVIA compound film on the workpiece will now be presented. FIGS. 14A and 14B show in a side cross sectional view and a front cross sectional view, a continuous reactor 2100 including peripheral reactor walls 2102 and a process gap 2104 defined by the peripheral reactor walls 2102. A continuous workpiece 2105 having a front surface 2106A and a back surface 2106B is advanced through the process gap and over a bottom wall 2102A of the peripheral reactor walls 2102 while a top layer 2107 of the continuous workpiece 2105 is reacted and transformed. The top layer 2107 may be a precursor layer comprising Cu, at least one Group IIIA material and optionally at least one Group VIA material such as Se. The continuous workpiece 2105 enters the process gap 2104 through an entrance opening 2108A; it is advanced through the process gap while the top layer 2107 is reacted; and leaves the process gap 2104 through an exit opening 2108B of the process gap 2104. The top layer 2107 of the continuous workpiece is formed over a base layer 2110 including a contact layer 2111 and a flexible substrate 2112, thereby the top surface 2106A of the workpiece is the top surface of the top layer 2107 (see FIG. 14C). Before being advanced into the process gap, the top layer 2107 includes a precursor material comprising, for example, Cu, In, Ga and optionally Se, i.e., the top layer is a precursor layer before reaction in the continuous reactor 2100. As the workpiece is advanced through the process gap 2104 and reacted, the precursor material is converted into a Group IBIIIAVIA absorber material with the applied heat, and optionally, gaseous species comprising Group VIA materials. Therefore, the top layer 2107 of the continuous workpiece 2105 exiting the process gap 2104 comprises the absorber material, i.e. the top layer 2107 is fully converted into the absorber material. The process gap 2104 is heated by the heating elements placed inside or outside of the peripheral walls 2102, peripheral walls comprising bottom 2102A, top 2102B and side 2102C walls. The heating elements heat the peripheral walls 2102 which in turn heat the process gap and the continuous workpiece 2105 traveling through the process gap 2104. There may also be cooling coils to cool selected regions of the peripheral walls. In some designs there may be an insert within the cavity formed by the peripheral walls. In this case, the process gap is within the peripheral walls of the insert. Details of the exemplary reactors that can employ the present embodiment can be found in FIGS. 2, 4, 6, 7A, 8A, 8B, 9, 10A, 11A, 11B, 11E, 12A, 12B and 13. In general, the process gap 2104 includes a temperature profile of at least multiple sections, preferably three sections, to fully convert the precursor material layer on the base 2110 into the absorber layer. Approximate locations of the exemplary sections along the process gap 2104 can be seen along a reference line positioned below the continuous reactor 2100.

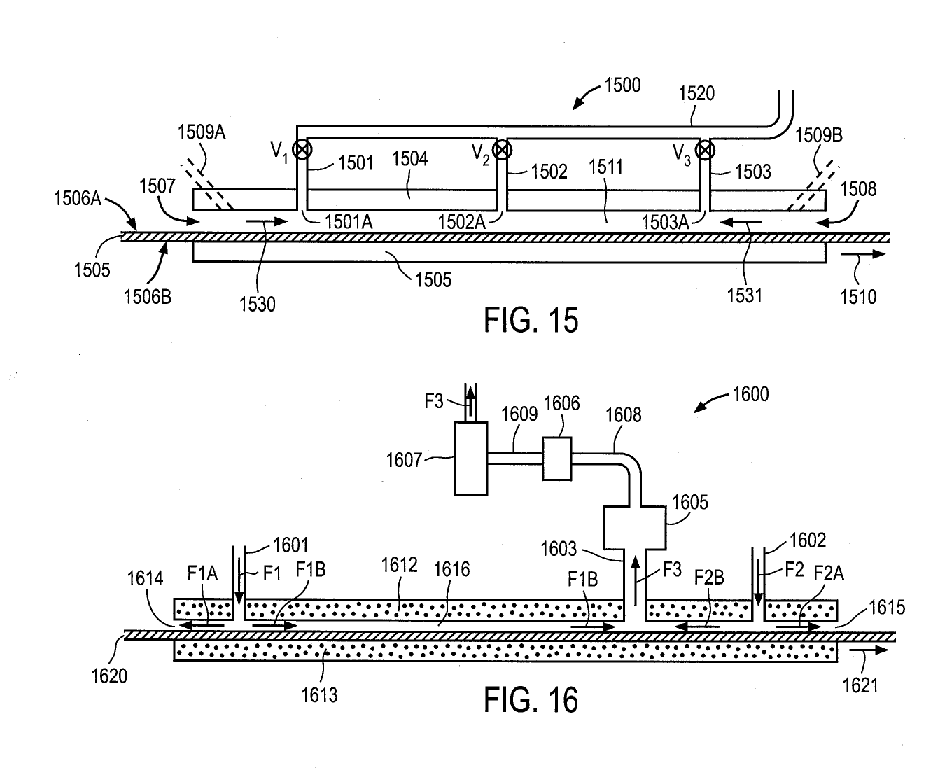

Accordingly, a low temperature section 2104A is located adjacent the entrance opening 2108A; a cooling section 2104C is located adjacent the exit opening 2108B of the process gap 2104; and a high temperature section 2104B is located between the low temperature section 2104A and the cooling section 2104C. Furthermore, the continuous reactor 2100 comprises a first reactor region 2100A and a second reactor region 2100B. The temperature in the low temperature section 2104A, the high temperature section 2104B and the cooling section 2104C may be in the range of 20-350° C., 400-600° C., and below 100° C., respectively. Unprocessed sections of the continuous workpiece 2105, entering the process gap 2104, may be unwrapped from a supply spool (not shown) and the processed portions, exiting the process gap, are taken up and wound around a receiving spool (not shown). During the process, inert gases such as nitrogen may be flowed into the process gap 2104 through the entrance opening 2108A and exit opening 2108B to form a diffusion barrier against volatile species such as Group VIA material containing vapors within the process gap 2104 to escape through the entrance opening 2108A and exit opening 2108B. Process gases may also be provided to the process gap 2104 by at least one gas inlet connected to the process gap 2104. Used gases and Group VIA containing vapors are removed from the process gap 2104 through an exhaust opening 2113 placed closer to the exit opening 2108B. It should be noted that other exhausts or exhaust openings located at different locations between the entrance opening 2108A and exit opening 2108B may also be utilized (see for example FIG. 15). Exhausts are preferably heated to temperatures above 250° C., preferably above 300° C., to avoid any condensation of Se and/or S species at these locations. Also cool exhaust lines would form a sink for Group VIA element vapors causing poor materials utilization within the reactor.

In the novel reactor designs of the embodiments herein it is possible to react the precursors with more than one species in a serial manner. In this case, it is necessary to separate the more than one gaseous species from each other within the process gap 2104 as previously discussed with reference to the design of FIG. 4. Another concern in the reactor is the enhancement of materials utilization. Reaction of precursor layers comprising Cu, In and Ga, with Se and/or S, for example, typically consumes much more Se or S than the amount necessary to form the CIGS(S) compound. This is because the Group VIA materials such as Se and S are relatively volatile materials and they are in vapor form at the high reaction temperatures which are typically in the range of 400-600° C. Hydrides (H₂Se, H₂S) containing Se and S, on the other hand, are gases even at room temperature. Therefore, during reaction with the precursor layer, these volatile species need to be contained as much as possible within as small a cavity as possible. When these volatile species arrive on the surface of the precursor layer they react with it and form non-volatile selenide and sulfide compounds. Therefore, increasing the residence time of the gaseous Se and S species over the precursor layer and increasing their rate of impingement onto the precursor layer surface are necessary to increase their utilization, i.e. their inclusion into the selenide and/or sulfide compounds that are forming as a result of the reaction. Any volatile Se and/or S species that do not find a chance to react with the precursor layer are directed to outside the process gap through the exhaust opening. Exhausted Se and/or S constitute un-utilized material, i.e. a materials loss from the reactor. Such loss increases the cost of the overall reaction process. Increasing the Group VIA materials utilization requires the gap 2104 to be as small or narrow as possible. Very narrow process gaps, such as a gap with a height of 2-3 mm, on the other hand, may cause scratching of the precursor layer during or after reaction, if the precursor layer touches the top wall 2102B of the peripheral walls 2102 as it moves through the process gap.

In the design of the embodiments herein, in order to avoid any physical contact between the top layer 2107 of the continuous workpiece 2105 and the top wall 2102A of the peripheral walls 2102 when the continuous workpiece 2105 is advanced through the process gap 2104, one or more movable buffer members 2114 are placed adjacent the top wall 2102B, preferably in the high temperature section 2104B. In this embodiment the movable buffer members 2114 may be protection rollers that rotate and prevent any surface damage if the top layer 2107 touches them. The protection rollers 2114 are provided to prevent any scratching of the top layer 2107 if the continuous workpiece bows up against the top wall 2102B because of the thermal expansion caused by the entry of the continuous workpiece into the high temperature section 2104B from the low temperature section 2104A. This is a unique problem associated with continuous metallic webs or workpieces where a first portion of the web is kept at a low temperature, for example at room temperature, while the temperature of a second portion which is adjacent to the first portion is raised to an elevated temperature, such as to a temperature range of 250-600° C. In such a situation the second portion expands while the first portion stays the same. This causes the web to deform to absorb the dimensional differential (which is a width differential in the case of a thin and wide foil) between the first and second portions. Because of the low aspect ratio of the process gap 2104, the vertical distance between the top wall 2102B and the front surface 2106A of the continuous workpiece may be about 2-10 mm. Without the protection rollers 2114, in the high temperature section 2102B, the continuous workpiece may bow upwardly and the top layer 2107 may touch the top wall 2102B as it moves, resulting in damage to the absorber layer that is forming. In order to prevent this contact between the workpiece and top wall in such narrow process gaps, increasing the height of the gap to the 10-25 mm range may be considered as one of the solutions. However, as explained before, narrow gaps have attractive benefits in terms of increased materials utilization and efficient use of generated heat. Use of protection rollers results in further reduction of the height of the process gap, which further increases the efficiency of the reaction process. In one embodiment, the length of the protection rollers 2114 may be substantially equal to the width of the process gap 2104 and the protection rollers may be placed within the semi circular cavities 2115 extending along the width of the top wall 2102B. The length of the rollers may be in the range of 20-200 cm or longer depending on the width of the process gap 2104. The diameter of the rollers may be in the range of 2-20 mm, preferably in the range of 3-6 mm. They may be constructed using inert materials such as ceramics, quarts and graphite, or they may have inert coatings on their outer surfaces. The rollers may be driven (rotated by a motor) at a speed such that their surface linear velocity is about the same as the linear velocity of the moving workpiece. Alternately, the rollers may be idle rollers that rotate only when touched by the workpiece. Although in FIG. 14A there are only three of the protection rollers 2114 shown, there may be more or less rollers 2114 in the various locations along the high temperature section 2104B within the first reactor section 2100A and second reactor section 2100B.

The principles of using the movable buffer members described in the embodiments herein to avoid physical damage to the top layer 2107 of the continuous workpiece 2105 may be advantageously used for further narrowing the process gap 2104 at a selected location without concern about damage to the top layer 2107 of the continuous workpiece 2105. Referring to FIG. 14A, a movable isolation and buffer member 2116 located close to the exhaust opening 2113 effectively reduces the distance between the top wall 2102A and the front surface 2106A of the continuous workpiece and divides the reactor into two segments; the first reactor segment 2100A and the second reactor segment 2100B. Narrowing the process gap at this location before the exhaust opening 2113 advantageously allows efficient use of two different vapor species in the two different segments (the first reactor segment 2100A and the second reactor segment 2100B) of the process gap. Referring to FIGS. 14A and 14B, in this embodiment, the movable isolation and buffer member 2116 may be an isolation roller that is dimensioned to form a reduced gap RG between a surface 2118 of the bottom wall 2102A and a lower end 2120 of the isolation roller 2116. FIG. 14B is a front cross sectional view of the continuous reactor 2100 showing an exemplary isolation roller 2116 within the process gap defined by the peripheral walls 2102 comprising the bottom wall 2102A, the top wall 2102B and the side walls 2102C. At the reduced gap RG the vertical distance between the front surface 2106A and the lower end 2120 of the isolation roller may be very small, e.g. in the range of 1-2 mm. As shown in FIG. 14B, the isolation roller 2116 extends along the width of the process gap 2104 and is movably attached to the side walls 2102C so that if the front surface 2106A of the continuous workpiece touches it, the isolation roller 2116 rotates and prevents any excessive friction and damage on the front surface 2106A. As shown in FIGS. 14A and 14B, the isolation roller 2116 may be movably placed into a semi circular cavity formed in the top wall 2102B of the process gap 2104.

The isolation function of the isolation roller 2116 may be seen in a partial view of the continuous reactor 2100 shown in FIG. 14C. The isolation roller 2116 blocks the majority of the gas flow from the portion of the process gap within the first reactor segment 2100A into the portion of the process gap within the second reactor segment 2100B. This serves two purposes; i) reduced gap under the isolation roller 2116 increases the velocity of the gas under the isolation roller 2116 (shown by arrow 2120), establishing an efficient diffusion barrier against any appreciable transfer of gaseous species from the portion of the process gap within the second reactor segment 2100B into the portion of the process gap within the first reactor segment 2100A, ii) effective diffusion barrier between the two reactor segments allows reduction of the gas flow from the portion of the process gap within the first reactor segment 2100A towards the exhaust opening 2113, increasing the residence time of any Group VIA volatile species in the portion of the process gap within the first reactor segment 2100A. As discussed before, increased residence time increases materials utilization. We will now describe an example for the growth of a GIGS absorber layer on a flexible base.

A workpiece comprising a precursor layer deposited on a flexible base may be used in the reactor of FIG. 14A. The exemplary precursor layer comprises metallic Cu, In and Ga species as well as elemental Se. A portion of the workpiece travels from the entry 2108A to exit 2108B and reaction within the process gap forms the CIGS layer on the base. Inert gases such as nitrogen are flowed into the process gap from the entry 2108A and exit 2108B openings. The flow from the entry opening may be 1-10% of the flow from the exit opening. For example, the flow from the exit opening may be in the range of 0.5-10 liters/minute, whereas the flow from the entry opening may be as small as 0.005 liters/minute. As described before, existence of the isolation roller 2116 allows the use of such low flows within the first reactor segment 2100A. As the portion of the workpiece is moved from left to right within the first reactor segment 2100A, the Cu, In, Ga and Se in the precursor layer starts reacting with each other. Some of the Se evaporates and fills the portion of the process gap within the first reactor segment 2100A since it is volatile. However, the small gas flow within the first reactor segment 2100A keeps the evaporated Se vapors within the process gap portion between the entry 2108A and the isolation roller 2116 for a long period of time so that they can be reacted with precursor layer in other portions of the workpiece being fed through the entry 2108A. Once the reacted portion of the workpiece enters the second reactor segment 2100B, it may be treated with the inert gas present in the portion of the process gap within the second reactor segment 2100B until it exits the reactor through the exit 2108B. Alternately, a S source such as H₂S may be fed into the portion of the process gap within the second reactor segment 2100B and further reaction of the CIGS film (formed in the first reactor segment 2100A) with S may be achieved to form a CIGS(S) compound layer. Presence of the isolation roller 2116 does not allow substantial diffusion of S species from the portion of the process gap within the second reactor segment 2100B into the portion of the process gap within the first reactor region 2100A.

It should be noted that more isolation rollers may be placed in various other locations within the process gap 2104 to enhance material utilization and/or improve isolation between various reactor segments or regions. For example, an additional isolation roller (not shown) may be placed to the right of the exhaust opening 2113 to improve materials utilization of gaseous species in the second reactor segment 210013 between the exit opening 2108B and the additional isolation roller. The additional isolation roller also substantially prevents the gaseous species coming from the first reactor segment 2100A towards the exhaust opening 2113, from entering the second reactor segment 2100B between the exit opening 2108B and the additional isolation roller. This way two different reactions may be carried out in the two segments of the reactor very efficiently and avoiding damage to the solar cell absorber layer surface. Isolation rollers may even be used at the entry and exit openings to reduce the inert or process gas flows through these openings while preventing the volatile species from coming out of the reactor through these openings. Also it is possible to place rollers into the bottom peripheral walls to reduce damage to the back side of the workpiece. Planarization rollers may also be used in a low temperature segment of the reactor as described in U.S. patent application Ser. No. 12/345,389, which application is expressly incorporated by reference herein.

Through control of the gas flows into and the gas flows put of the process gaps of the exemplary reactors shown in FIGS. 2, 4, 6, 7A, 8A, 8B, 9, 10A, 11A, 11B, 11E, 12A, 12B, 13, 14A, 14B and 14C, it is possible to further improve the process results from the reaction of precursor layers to form Group IBIIIAVIA compound absorber layers. Such approaches also improve the versatility of the reactors or reaction tools as will be described below.

In an embodiment of the present invention, a multi exhaust reactor comprises multiple exhaust outlets connected to a process gap of the reactor between an entrance opening and an exit opening of the process gap. The entrance opening and the exit opening of the process gap may be connected to a supply chamber and a receiving chamber, respectively, in a sealed manner. By controlling each exhaust outlet independently with valves, the process time of a precursor layer may be extended or shortened in a segment or section of the process gap. This versatility of the reactor allows changing and controlling the composition and the molar ratio of an absorber layer obtained by reacting a precursor layer using the reactor of the present invention. FIG. 15 shows a schematic side view of an exemplary multi-exhaust reactor 1500 with a first exhaust 1501 having a first exhaust opening 1501A, a second exhaust 1502 having a second exhaust opening 1502A and a third exhaust 1503 having a third exhaust opening 1503A. All the exhausts pass through a wall, in this example a top wall 1504 of the reactor 1500, and then join to a common exhaust line 1520, which may be forwarded to a trap system (not shown) to collect the Group VIA materials species from the exhaust gas. There may be a first valve V1, a second valve V2 and a third valve V3 controlling the flow through the first exhaust 1501, the second exhaust 1502 and the third exhaust 1503, respectively. During the process, a workpiece 1506 with a top surface 1506A and a bottom surface 1506B is moved in the direction of the arrow 1510 through a process gap 1511 defined by the top wall 1504, a bottom wall 1505 and side walls (not shown in this view). At the same time a first gas is introduced into the process gap through the entrance opening 1507 and/or an optional first gas inlet 1509A that is shown with dotted lines. A second gas is introduced into the process gap through the exit opening 1508 and/or an optional second gas inlet 1509B that is shown with dotted lines. Referring to FIG. 15, the first exhaust 1501, the second exhaust 1502 and the third exhaust 1503 are connect to the process gap through the first exhaust opening 1501A, the second exhaust opening 1502A and the third exhaust opening 1503A, respectively. A temperature profile is established along the process gap between the entrance opening 1507 and the exit opening 1508. In his established temperature profile the temperature of the first exhaust opening 1501A, the second exhaust opening 1502A and the third exhaust opening 1503A are at a temperature that is higher, preferably at least 150° C. higher than the melting temperatures of all the Group VIA materials processed in the reactor 1500. For example, if Se and S are both being used in the reaction, the temperature at all the exhaust opening positions are higher than about 220° C. (which is the melting point of Se), preferably higher than about 370° C. An example of the growth of a Cu(In,Ga)(S,Se)₂ film (or CIGS(S) film) will be described below to demonstrate the operation of the reactor 1500.

The top surface 1506A of the workpiece 1506 may comprise a precursor layer to be converted into a CIGS(S) layer. As described before there are many different types of such precursors, but a precursor layer comprising Cu, In, Ga and Se will be described below. In this exemplary process, the first gas may be an inert gas such as nitrogen (N₂) establishing a first gas flow 1530 which moves in the same direction as the workpiece 1506, and the second gas may be a S containing gas such as H₂S establishing a second gas flow 1531, which is in the opposite direction of the workpiece motion. Accordingly, as a portion of the workpiece is moved from the entrance opening 1507 towards the exit opening 1508, that portion of the precursor layer starts reacting, i.e. Cu, In, Ga and Se within the precursor layer start reacting with each other and then when they get exposed to S species they all start reacting with S present in the process gap 1511. The reactor 1500 shown in FIG. 15 is versatile because it can vary the reaction with S species and therefore control how much S is present in the reacted film or the absorber film once it emerges from the exit opening 1508. For example, if the valve V1 is open and the valves V2 and V3 are closed, then the first gas flow 1530 mainly flows over the workpiece between the entrance opening 1507 and the first exhaust opening 1501A. In this configuration the second gas flow 1531 comprising S, flows between the exit opening 1508 and the first exhaust opening 1501A. Both the first gas flow 1530 and the second gas flow 1531, along with any reaction by-products, are directed outside of the process gap by the first exhaust 1501. Since in this example the first gas is an inert gas, a portion of the precursor layer travelling between the entrance opening 1507 and the first exhaust opening 1501A is exposed to the inert gas and possibly to a vapor of Se resulting from the evaporation of Se from the portion of the precursor layer, due to the heating in the section of the process gap between the entrance opening 1507 and the first exhaust opening 1501A. Therefore, during a time period “t₁” when the portion of the precursor layer is travelling between the entrance opening 1507 and the first exhaust opening 1501A, the Cu, In and Ga species in the portion of the precursor layer react with Se, forming selenide species. When the portion of the precursor layer passes the first exhaust opening 1501A and travels towards the exit opening 1508 for a time period “t₂”, it gets exposed to more and more S species. Therefore, reaction with S is carried out for the time period “t₂”. Because of the reverse direction of the second gas flow 1531, the portion of the precursor moving through the S-containing section of the process gap 1511 is exposed to fresher S-containing gas as it moves closer to the exit opening 1508. This is preferable to form a high quality absorber layer with a fresh surface rather than a surface exposed to reaction by-products. The resulting absorber layer of the portion may have a chemical formulation that can be represented as Cu(In,Ga)SₓSe_{y}, a material with a first S/(S+Se) ratio of x/(x+y).

If the valve V3 is open and the valves V1 and V2 are closed, then the first gas flow 1530 mainly flows over the workpiece between the entrance opening 1507 and the third exhaust opening 1503A. In this configuration the second gas flow 1531 comprising S, flows between the exit opening 1508 and the third exhaust opening 1503A. Both the first gas flow 1530 and the second gas flow 1531, along with any reaction by-products, are directed outside of the process gap by the third exhaust 1503. Since in this example the first gas is an inert gas, a portion of the precursor layer travelling between the entrance opening 1507 and the third exhaust opening 1503A is exposed to the inert gas and possibly to a vapor of Se resulting from the evaporation of Se from the portion of the precursor layer, due to the heating in the section of the process gap between the entrance opening 1507 and the third exhaust opening 1503A. Therefore, during a time period “t₃” when the portion of the precursor layer is travelling between the entrance opening 1507 and the third exhaust opening 1503A, the Cu, In and Ga species in the portion of the precursor layer react with Se, forming selenide species. When the portion of the precursor layer passes the third exhaust opening 1503A and travels towards the exit opening 1508 for a time period “t₄”, it gets exposed to more and more S species. Therefore, reaction with S is carried out for the time period “t₄”. The resulting absorber layer of the portion may have a chemical formulation that can be represented as Cu(In,Ga)S_{z}Se_{w}, a material with a second S/(S+Se) ratio of z/(z+w).

Since, tᵢ<t₃ and t₂>t₄, the compositions of the absorber layers obtained from the two exemplary cases given above would differ in relative S and Se content in a way that can be represented by the relationship x/(x+y)>z/(z+w). In other words, the location of the used exhaust opening would determine the S/(S+Se) molar ratio of the absorber layer and therefore its bandgap and electronic quality. However, one specific S/(S+Se) molar ratio, which may be good for a specific Cu/(In+Ga) ratio of a precursor layer may not be good for another precursor layer with a different Cu/(In+Ga) ratio. Therefore, a multi-exhaust tool such as the one shown in FIG. 15 is versatile and can be used to optimize the reaction processes for a wide variety of precursor layers with a wide variety of Cu/(In+Ga) molar ratios. It should be noted that, in the above example, the second exhaust 1502 could be employed by opening the valve V2 and closing the valves V1 and V3, to obtain a third S/(S+Se) molar ratio of a formed absorber layer, the third molar ratio having a value between the first ratio and the second ratio. The reactor 1500 may also be operated by one or more of its valves in partially closed position rather than the completely closed positions as described in the above example.

In the reactor designs depicted in FIGS. 2, 4, 6, 7A, 8A, 8B, 9, 10A, 11A, 11B, 11E, 12A, 12B, 13, 14A, 14B, 14C and 15, a preferred embodiment comprises running these reactors as a first oxygen or air free process gas is flowed in a direction from the entrance opening towards the exhaust and a second oxygen or air free process gas is flowed in a direction from the exit opening towards the exhaust, the exhaust or a number of exhausts being located between the entrance opening and the exit opening of a process gap. As explained above this preferred embodiment provides for a diffusion barrier against the vapor or gas species of Group VIA materials present in the hot zones of the process gap to travel towards the entrance opening and the exit opening and condense on the unreacted or unprocessed portions of the workpiece near the entrance opening and the already reacted portions of the workpiece near the exit opening. This is very important, especially at the exit opening because Group VIA materials condensing or precipitating on the already formed Group IBIIIAVIA compound layer deteriorate the surface quality of this layer and unless removed by some means (chemical or physical means) does not allow fabrication of high efficiency solar cells on such absorbers with a surface layer of Group VIA material.

There are various ways of establishing a diffusion barrier against the flow of volatile Group VIA materials towards the entrance and exit openings of the reactors of the present inventions. One way is to connect the entrance and exit openings to a first port (also called supply chamber or unwind chamber or port) and a second port (also called receiving chamber or rewind chamber or port), respectively (see for example FIGS. 2 and 8A), and seal the first port, the second port and the process gap from atmosphere. This way, the first and the second process gas flows may be established towards the exhaust opening(s) without concern of air entering the process gap through the entrance opening and the exit opening. If the first port and the second port are open to the atmosphere or if they are leaky, however, while establishing a barrier against flow of volatile Group VIA species through the entrance opening and the exit opening towards the first port and the second port, one has to also establish a barrier against air or oxygen flow through the entrance and exit openings into the hot zones of the process gap.

As will be described below in another embodiment of the present invention, a reactor may comprise multiple gas inlets and exhaust outlets connected to a process gap of the reactor between an entrance opening and an exit opening of the process gap. The entrance opening and the exit opening of the process gap may be open to the atmosphere. Preferably a first gas inlet may be connected adjacent the entrance opening and a second gas inlet connected adjacent the exit opening of the process gap so that when an inert gas is applied through the first and second gas inlets, the inert gas flow forms a diffusion barrier, namely a first diffusion barrier and a second diffusion barrier, efficiently sealing the entrance and exit openings. FIG. 16 shows a schematic side view of an exemplary reactor 1600 with a process gap 1616 defined by a top wall 1612, a bottom wall 1613 and side walls (not shown). The process gap 1616 has an entrance opening 1614, an exit opening 1615 through which a workpiece 1620 may pass through in the direction of the arrow 1621. The workpiece 1620 comprises a precursor layer that will be reacted in the process gap 1616 as described before. In this example the precursor layer may comprise Cu, In, Ga and Se and a CIGS absorber layer may be formed as a result of processing in the reactor 1600.

The reactor 1600 has a first gas inlet 1601 connected to the process gap 1616 near the entrance opening 1614 and a second gas inlet 1602 connected to the process gap near the exit opening 1615. A first process gas, which is preferably an air-free or oxygen free gas, is flowed through the first gas inlet 1601 to establish a gas flow Fl. A second process gas, which is also an air free or oxygen free gas, is flowed through the second gas inlet 1602 to establish a gas flow F2. There is an exhaust 1603 connected to the process gap 1616 between the first gas inlet 1601 and the second gas inlet 1602. An optional trap 1605 is connected to the exhaust 1603 to condense and collect the Group VIA species (Se in this example). The trap 1605 is further connected to the inlet of a flow controller 1606 such as a mass flow controller through a first pipe 1608. The outlet of the flow controller 1606 is connected to the inlet of a vacuum pump 1607 through a second pipe 1609. There may also be filters (not shown) before the mass flow controller and/or the vacuum pump 1607. The outlet of the pump 1607 discharges into the atmosphere. Since this design of the reactor 1600 operates at substantially the atmospheric pressure, control of the gas flow F3 through the exhaust 1603 is established through the use of the flow controller 1606 and the pump 1607. The pump 1607 creates vacuum or a pressure that is lower than the atmospheric pressure in the second pipe 1609 which is connected to the outlet of the flow controller 1606. The pressure of gases at the inlet (the first pipe 1608) of the flow controller 1606, on the other hand, is nearly atmospheric. This pressure differential between the inlet and outlet of the flow controller 1606 allows it to control the gas flow F3 accurately.

During processing, as the workpiece 1620 is moved through the heated process gap 1616 with a pre-set temperature profile, the gas flow F3 is set at a value that is smaller than the sum of the gas flow F1 and the gas flow F2, i.e. F3<F1+F2, and F3=F1B+F2B, wherein F1B and F2B are gas flows originating from F1 and F2 and flowing in the process gap 1616 towards the exhaust 1603. This setting assures that two other gas flows F1A and F2A are established near the entrance opening 1614 and the exit opening 1615, respectively. The gas flow F1A flows through a portion of the process gap 1616 between the first gas inlet 1601 and the entrance opening 1614, towards the entrance opening 1614. Thus the gas flow F1A establishes a barrier against air entering the process gap 1616 from outside through the entrance opening 1614. The gas flow F2A flows through a portion of the process gap 1616 between the second gas inlet 1602 and the exit opening 1615, towards the exit opening 1615. Thus the gas flow F2A establishes a barrier against air entering the process gap 1616 from outside through the exit opening 1614. As can be understood from the above discussion, while the flows F1A and F2A are used to stop diffusion of air into the process gap 1616, the flows F1B and F2B are utilized as barriers against the vaporized Group VIA material (Se in this example) to diffuse towards the entrance opening 1614 and the exit opening 1615, respectively. This is very important since Group VIA materials are poisonous and cannot be allowed to leave the process gap 1616 through the entrance opening 1614 or the exit opening 1615. Furthermore, as explained before, their condensation on the workpiece, especially after formation of the Group IBIIIAVIA absorber layer deteriorates the performance of such absorber layer as a solar cell material. The reactor 1600 is very versatile; therefore by choosing the position of the exhaust, the number of exhausts, and by selecting the values for the gas flows F1, F2 and F3, the process results can be influenced and improved. For example, for a 30 cm wide 5-10 mm high process gap: if F1 is 5 liters/min, F2 is 5 liters/min and F3 is 2 liters/min; if both the first process gas and the second process gas are nitrogen; and if the exhaust position is closer to the second gas inlet 1602 such that resistance to gas flow from the first gas inlet 1601 position to the exhaust 1603 position through the process gap 1616 is twice the resistance from the second gas inlet 1602 position to the exhaust 1603 position; the values of the various gas flows would be about: F1A=4.33 liters/min, F1B=0.67 liters/min, F2A=3.67 liters/min, and F2B=1.33 liters/min. In this example, the relatively high flows of F1A and F2A keep air out of the process gap 1616 by being effective diffusion barriers, while the relatively low flows of F1B and F2B push the Se vapors over the workpiece for their better utilization in the reaction and keep the Se vapors away from the entrance opening 1614 and the exit opening 1615. It should be noted that in this design it is preferable that the portion of the process gap 1616 around the exhaust 1603 and the exhaust 1603 itself be kept at high temperature such as at a temperature over 350° C., preferably at a temperature over 400° C. to avoid condensation of Se in such locations. It should also be noted that more than one gas inlets near the entrance opening 1614 and more than one gas inlets near the exit opening 1615 may be used. Additional gas inlets (not shown) may also be used between the first gas inlet 1601 and the second gas inlet 1602 to introduce other gases into the process gap 1616. For example, to form a CIGS(S) absorber layer a third gas inlet (not shown) may be connected to the process gap 1616 between the first gas inlet 1601 and the exhaust 1603. A sulfur bearing gas such as H₂S may be introduced through this third gas inlet at a flow rate of F4. In this case the gas flow F3 needs to be adjusted such that F1B>F4 and F3=F1B+F4+F2B, and F3<F1+F2+F4. In this case the flows F1B and F2B stop both Se and S species from reaching the entrance opening 1614 and the exit opening 1615 while the precursor of the workpiece is reacted with both Se and S in the process gap 1616 to form the CIGS(S) absorber layer. It should be noted that the reactor designs described above may benefit from the rollers in the bottom wall or the top wall (i.e. movable barriers) described in FIGS. 12A, 13 and 14A. It is also possible that web valves described in FIG. 13 be utilized in the designs of FIGS. 15 and 16. In this case it is possible to close the web valves and pump down the process gap before initiating the reaction process. After the process gap is pumped down, preferably through the exhaust, it may be back filled with nitrogen, then the web valves may be opened, all the gas flows (F1, F2, F3) may be established and the reaction of the precursor layer of the workpiece may be initiated by starting to move the web.

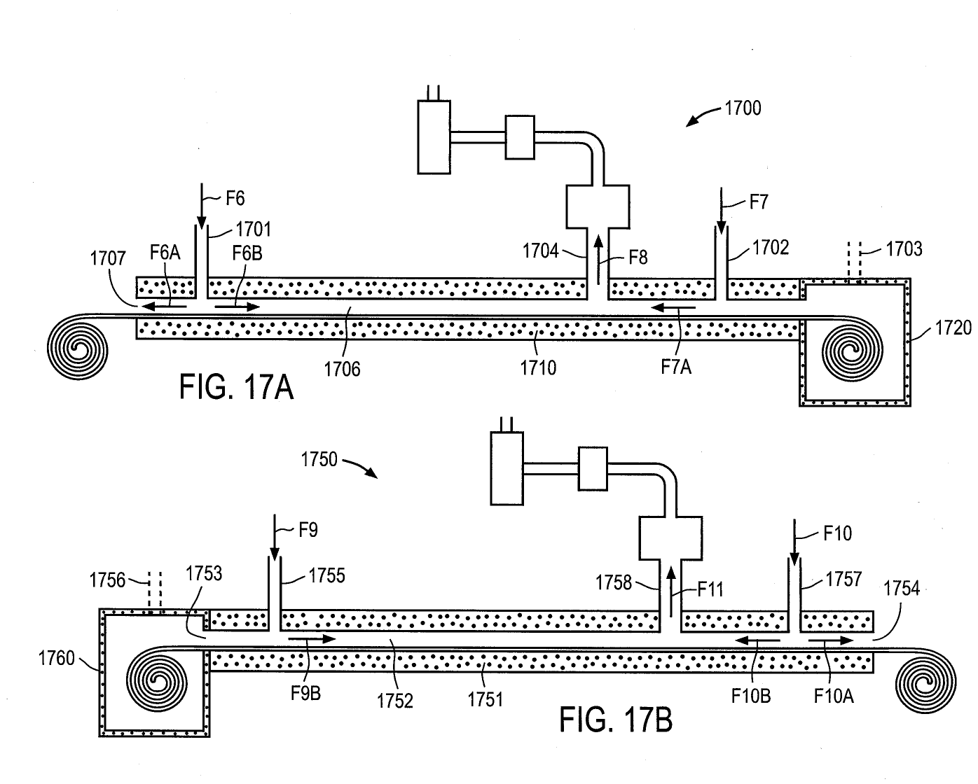

Alternatively, it is also possible to have one side of the process gap open to the atmosphere and the other side to be sealed using a chamber or port. Such a system would also have the capability to carry out reactions at around atmospheric pressure. FIG. 17A shows a system 1700 comprising a reactor section 1710 and a rewind port 1720 or receiving chamber that are attached to each other in a sealed way. Details of the reactor section 1710 may be similar to the reactor of FIG. 16 and are not shown in FIG. 17A. A first process gas inlet 1701 and a second process gas inlet 1702 are shown. It should be noted that in this design it possible to have a process gas inlet 1703 in addition to or in place of the second process gas inlet 1702. The functionality of the system 1700 using the second process gas inlet 1702 will be described below.

In operation the rewind port 1720 or receiving chamber and optionally the process gap 1706 may be evacuated and backfilled with nitrogen to eliminate air. Then the gas flows F6, F7 and F8 are established such that F8<F6+F7, and F8=F7A+F6B, where F7A=F7. In this case, there would be no flow from the second gas inlet 1702 towards the exit opening 1708 of the process gap 1706 since the rewind port 1720 is sealed and cannot be pressurized. Consequently, all of the flow F7 flows towards the exhaust 1704 as flow F7A. It should be noted that in this case the flow F6A which forms a barrier against air diffusion into the process gap 1706 through the entrance opening 1707 can be simply selected by adjusting the flows F6, F8 and F7. The flow F8 is selected to be larger than F7 so that all of the F7 flow gets exhausted without moving towards the entrance opening 1707. The flow F8 is also selected to be smaller than F7+F6 so that a barrier against air diffusion is established at the entrance opening 1707. For example, for a 30 cm wide 5-10 mm high process gap: if F6 is 5 liters/min, F7 is 5 liters/min and F8 is 6 liters/min; and if the first process gas and the second process gas are nitrogen, under these conditions, irrespective of the exhaust position it would be easy to calculate that the values of F6A and F6B would be 4 liters/min and 1 liters/min, respectively. Increasing the value of F6 without changing the values of F7 and F8 would increase the value of the flow F6A, i.e. the barrier against air diffusion, while not influencing the flow F6B which is used for reaction and as a barrier against the Group VIA material diffusion towards the entrance opening 1707. The flow F7A acts as a diffusion barrier to prevent the Group VIA vapors from entering into the rewind port 1720 through the exit opening 1708, and it can be adjusted at will in this design since it is equal to F7.

Alternatively, it is also possible to use a sealed un-wind port attached to the entrance opening and have the exit opening exposed to the atmosphere as shown in the system 1750 of FIG. 17B. Such a system would also have the capability to carry out reactions at around atmospheric pressure. The system 1750 comprises a reactor section 1751 and an unwind port 1760 that are attached to each other in a sealed way. Details of the reactor section 1751 may be similar to the reactor of FIG. 16 and are not shown in this figure. A first process gas inlet 1755 and a second process gas inlet 1757 are shown. It should be noted that in this design it possible to have a process gas inlet 1756 in addition to or in place of the first process gas inlet 1755. The functionality of the system 1750 using the first process gas inlet 1755 will be described below.

In operation, the unwind port 1760 and optionally the process gap 1752 may be evacuated and backfilled with nitrogen to eliminate air. Then the gas flows F9, F10 and F11 are established such that F11<F9+F10, and F11=F9B+F10B, where F9B=F9. In this case, there would be no flow from the first gas inlet 1755 towards the entrance opening 1753 of the process gap 1752 since the unwind port 1760 is sealed and cannot be pressurized. Consequently, all of the flow F9 flows towards the exhaust 1758 as flow F9B. It should be noted that in this case the flow F10A, which forms a barrier against air diffusion into the process gap 1752 through the exit opening 1754, can be simply selected by adjusting the flows F9, F10 and F11. The flow F11 is preferably selected to be larger than F9 so that all of the F9 flow gets exhausted without moving towards the exit opening 1754. The flow F11 is also selected to be smaller than F9+F10 so that a barrier against air diffusion is established at the exit opening 1754. For example, for a 30 cm wide 5-10 mm high process gap: if F9 is 1 liters/min, F10 is 8 liters/min and F11 is 3 liters/min; and if both the first process gas and the second process gas are nitrogen, irrespective of the exhaust position it would be easy to calculate that the values of F10A and F10B would be 6 liters/min and 2 liters/min, respectively. Increasing the value of F10 without changing values of F9 and F11 would increase the value of the flow F10A, i.e. the barrier against air diffusion through the exit opening 1754, while not influencing the flow F10B which is used for reaction and as a barrier against the Group VIA material diffusion towards the exit opening 1754. The flow F9B acts as a diffusion barrier to prevent the Group VIA vapors from entering into the unwind port 1760, and it can be adjusted at will in this design since it is equal to F9.

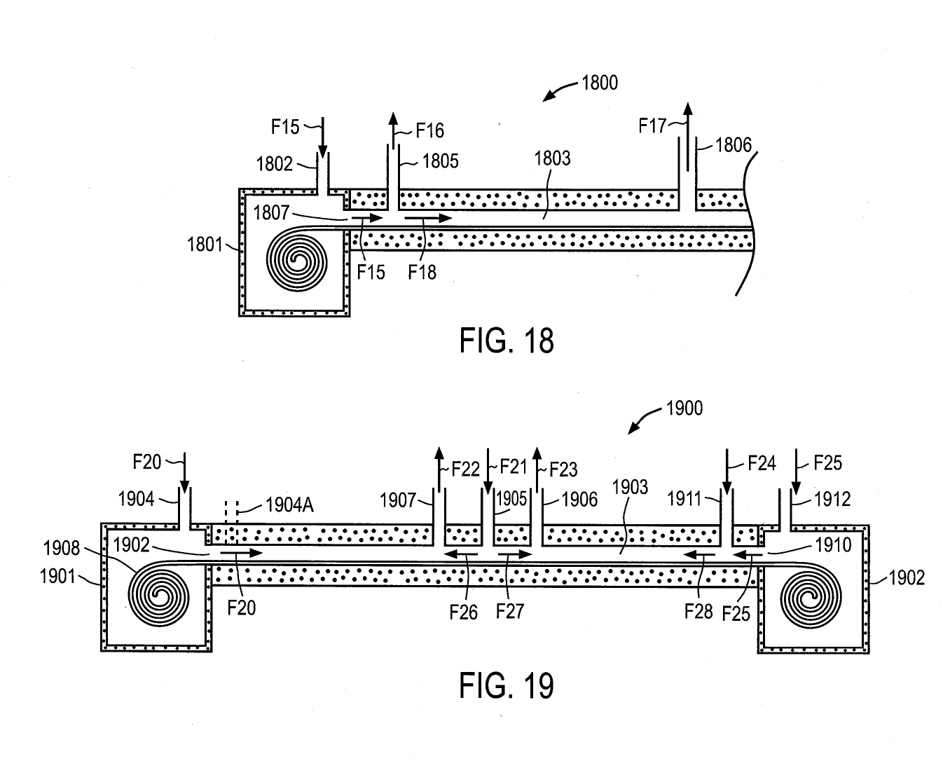

As indicated before, the functionality of the systems in FIGS. 2, 4, 6, 7A, 8A, 8B, 9, 10A, 11A, 11B, 11E, 12A, 12B, 13, 14A, 14B, 14C, 15, 16, 17A and 17B may be further improved, according to need, by adding more gas inlets and/or exhausts to the system. As will be described below in another embodiment of the present inventions, a reactor may comprise multiple gas inlets and exhaust outlets connected to a process gap of the reactor between an entrance opening and an exit opening of the process gap. In this embodiment, if a supply chamber or unwind port is connected to the entrance opening of the process gap in a sealed manner, a first diffusion barrier may be formed at the entrance opening by applying an inert gas flow through an external gas inlet connected to the supply chamber. The flow of this inert gas into the process gap may be controlled by an exhaust or gas outlet connected adjacent the entrance opening of the process gap. FIG. 18 shows a portion of such system having the components close to its unwind port. The system 1800 has an unwind port 1801 with a gas inlet 1802. There are two exhausts connected to the process gap 1803, a primary exhaust 1806 and a secondary exhaust 1805. Both the primary exhaust 1806 and the secondary exhaust 1805 have gas flow controllers and vacuum pumps connected to them, as described before, so that gas flow out of these exhausts can be pre-selected and controlled at will. In operation, the unwind port 1801 and optionally the process gap 1803 may be evacuated and backfilled with nitrogen to eliminate air. Then, the gas flows F15, F16 and F17 may be established. In this design, selection of the gas flows F15 and F16 pre-determines the quality of the gas barrier against diffusion of the Group VIA material vapors into the unwind port 1801 through the entrance opening 1807 of the process gap 1803, as well as the process gas flow F18 that pushes the Group VIA material vapors over the workpiece surface for their better utilization. Under certain process conditions it may be desirable to increase the barrier gas flow F15 to obtain better barrier quality but reduce the process gas flow F18 to increase the residence time of the Group VIA material vapors within the process gap 1803. It should be noted that if F18 is very high, then the Group VIA vapor species would be quickly pushed towards the primary exhaust 1806 and be exhausted as flow F17 causing poor materials utilization for the Group VIA materials in the precursor or in the process gap 1803. Therefore, in the reactor shown in FIG. 18 it is possible to make the flow F15 high as a barrier gas flow, but F18 low as the process gas flow. Accordingly, as an example, for a 30 cm wide 5-10 mm high process gap, if F15 is 8 liters/min and F16 is 7 liters/min, F18 would only be 1 liter/min. The high flow F15 would not allow any Group VIA vapors to enter the unwind port 1801, and at the same time the low flow F18 would improve Group VIA materials utility in the process gap 1803.

As will be described below in another embodiment of the present inventions, a reactor may comprise multiple gas inlets and exhaust outlets connected to a process gap of the reactor between an entrance opening and an exit opening of the process gap. In this embodiment, the ends of the process gap may be sealed with a supply chamber or unwind chamber or port and a receiving chamber or rewind chamber or port. Accordingly, a first diffusion barrier may be formed at the entrance opening of the process gap; a second diffusion barrier may be formed at the exit opening of the process gap; and a third diffusion barrier may be formed between the first and the second diffusion barriers. FIG. 19 shows a system 1900 designed with the capability of carrying out two different reactions. The system 1900 is similar to the reactor system 400 (see FIG. 4) and is re-drawn with the unwind and rewind chambers or ports to explain in detail how such a reactor can be so versatile if one closely controls the flow of gas through its exhausts. The system 1900 has an unwind port 1901 and a rewind port 1902 that are sealably attached to the process gap 1903 as explained before. There are various gas inlets and exhausts the functions of which will now be explained using an example of forming a CIGS(S) absorber layer on a workpiece 1908 with a precursor layer comprising Cu, In, Ga and Se, as it travels from the unwind port 1901, through the entrance opening 1909 and the exit opening 1910 of the process gap 1903 and into the rewind port 1902. During processing, an inert gas flow F20 is flowed into the unwind port 1901 through a first gas inlet 1904. The inert gas may be nitrogen and it may also be flowed into the reactor through an optional gas inlet 1904A in addition to or in place of the first gas inlet 1904. However, the process will be still explained using the inert gas flow F20 coming through the first gas inlet 1904. Another gas, which may still be an inert gas such as nitrogen, is flowed into the process gap 1903 through a second gas inlet 1905 establishing a gas flow F21. A first exhaust 1907 and a second exhaust 1906 are connected to the process gap on two sides of the second gas inlet 1905. Both the first exhaust 1907 and the second exhaust 1906 are connected to gas flow controllers and vacuum pumps (or to a single pump that may operate both), which are not shown in FIG. 19 but were previously described. Exhaust systems with the mass flow controllers and pumps establish gas flows F22 and F23 through these exhausts as shown in FIG. 19. A third gas inlet 1911 may be used to bring a flow F24 of an S-bearing gas such as H₂S. An optional fourth gas inlet 1912 may establish an inert gas flow F25 coming into the sealed rewind port 1902. During operation, the flow F22 is pre-set so that F22>F20, the flow F23 is set so that F23>F24+F25, and the flow F21 is establish so that it is equal to (F22−F20+F23−F24−F25). This way an inert gas flow F26 is established in a section of the process gap 1903 between the second gas inlet 1905 and the first exhaust 1907, the gas flow F26 flowing in opposite direction of the gas flow F20 and forming a barrier against diffusion of Se vapors that may be generated in the first section of the process gap 1903 between the entrance opening 1909 and the first exhaust 1907. It should be noted that as a portion of the workpiece 1908 travels through this first section of the process gap 1903, all the ingredients (Cu, In, Ga, Se) in the precursor layer starts reacting, and thus forming a CIGS type material. During this process, some Se vaporizes in the first section of the process gap 1903 and it may have to be confined in this first section. The inert gas flow F26 serves this purpose of confining Se vapors in the first section of the process gap 1903. The inert gas flow F20 acts as a barrier against Se diffusion into the unwind port 1901 through the entrance opening 1909, as described before. The gas flow F27 flowing in opposite direction of the gas flow F26 forms a barrier against diffusion of gaseous S species that are present in a second section of the process gap 1903, between the exit opening 1910 and the second exhaust 1906, into the first section. It should be noted that as the portion of the workpiece 1908 travels through this second section of the process gap 1903, the CIGS type layer formed in the first section of the process gap 1903 reacts with the S species in the second section, thus forming a CIGS(S) absorber layer before exiting into the rewind port 1902 through the exit opening 1910. The inert gas flow F25 acts as a barrier against S diffusion into the rewind port 1902 through the exit opening 1910, as described before.

The design in FIGS. 19 and 4 has the capability of applying different process gasses or vapor species to the workpiece in different sections of the reactor with minimal intermixing between the different vapor species. For example, if the flow F20 is set at 1 liter/min and the flow F25 is also set as 1 liter/min as barrier gas flows against Se and S vapor diffusion into the unwind and rewind ports, respectively; if the flow of the S-bearing gas is 0.5 liters/min, and the flow F21 is set to 12 liters/min; and if the exhaust flows F22 and F23 are set at 7 liters/min and 7.5 liter/min, respectively, such setup would approximately result in the gas flows of: F20=1 liter/min, F26=6 liters/min, F22=7 liters/min, F21=12 liters/min, F27=6 liters/min, F23=7.5 liters/min, and F28=F24+F25=1.5 liters/min. As can be appreciated from the above discussion, the barrier gas flows F20, F25, F26 and F27 may be easily changed and adjusted in this reactor design depending upon the diffusivities of the gaseous species used in the process gap. Such adjustment is allowed because both the inlet gas flows and the exhaust gas flows are closely controlled and balanced.

It should be noted that two or more of the reactor system design aspects described with reference to FIGS. 2, 4, 5A, 5B, 5C, 6, 7A, 8A, 8B, 9, 10A, 11A, 11B, 11C, 11E, 12A, 12B, 12C, 13, 14A, 14B, 15, 16, 17A, 17B, 18 and 19 in this application may be merged to create yet new designs with the functionalities of the two or more designs described with reference to the above figures.

It should also be noted that roll to roll reactors may have at least one of their entrance opening and exit opening open to the atmosphere. Such reactors preferably employ vacuum pump(s) that are connected to the outlet lines or outlet ports of the gas flow controllers in their exhaust systems. The reason, as explained before, is that in such reactors, which are open to the atmosphere, it is very difficult to build pressure within the process gap and therefore at the inlet lines or inlet ports of the gas flow controllers unless large volumes of gases are flowed in the process gap and the resistance to gas flow towards the entrance opening and/or the exit opening is increased within the process gap through the use of gap lowering restrictions or barriers, etc. This represents high usage of gases, which is not attractive from economical point of view. Also, as explained before, in some processes it is preferable to use low gas flows over the workpiece surface to increase the residence time of reactive species (such as Se and/or S vapors) in the process gap. In reactors with both the entrance opening and the exit opening of the process gap sealed using sealed chambers or ports (such as a supply chamber or unwind port and a receiving chamber or rewind port shown above), vacuum pumps may or may not be used in the exhaust systems since the process gaps of such reactors may be pressurized by small process gas flows into the process gaps and since the only way for the gasses to get out of the reactor is through the exhaust and the gas flow controllers . Usage of vacuum pumps in this case improves accuracy of the gas flow controllers by increasing the pressure differential between their inlet and outlet ports. Use of vacuum pumps also reduce or prevent possible back diffusion of air from the exit port of the gas flow controller back into its inlet port and eventually back into the process gap. Such back diffusion is especially important at low process gas flows through the exhaust, and if it happens, it deteriorates the photovoltaic quality of the Group IBIIIAVIA material layer being formed.

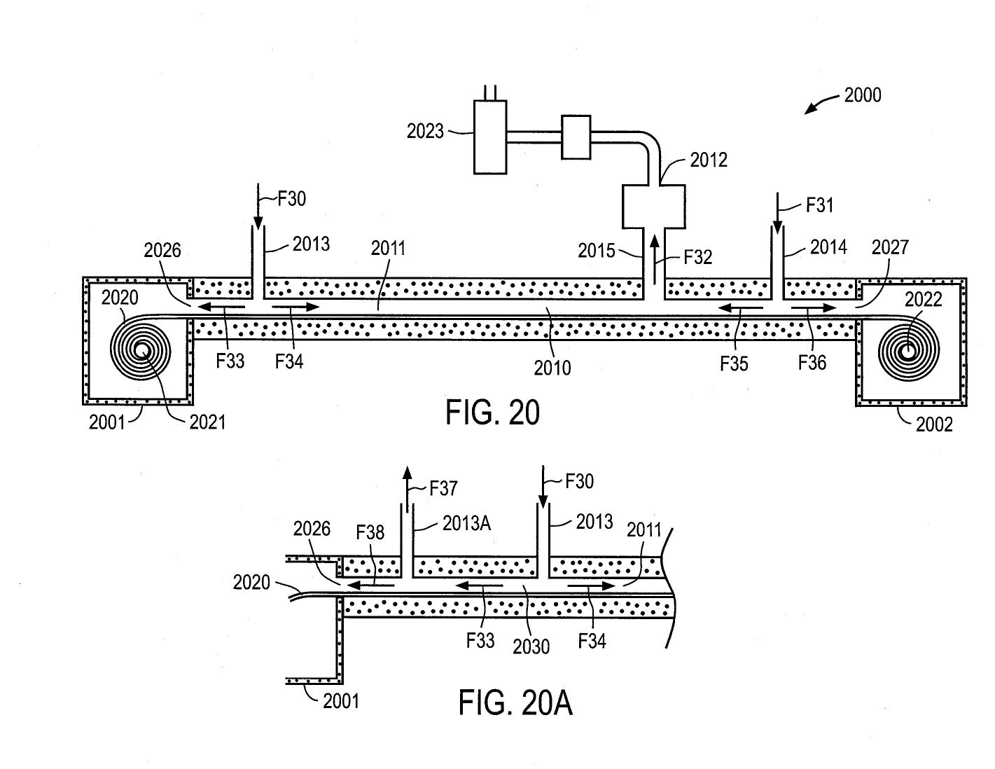

Reactors in FIG. 20 and FIG. 20A are examples that demonstrate merging of different embodiments of the present inventions to form alternative reactor systems. In the system 2000 of FIG. 20, a heated reactor section 2010 is sandwiched between a supply chamber 2001 or unwind port and a receiving chamber 2002 or rewind port that are attached to the process gap 2011 of the reactor section 2010 in a sealed way. Therefore, when the doors (not shown) of the supply and receiving chambers are closed and sealed, vacuum can be pulled into the common space in the system 2000. The common space includes the inside volumes of the supply chamber, the receiving chamber, and the process gap. The valve(s) that may be present in the exhaust system 2012 and as inlets that need to be closed during this vacuum pumping step are not shown to simplify the drawing. A first gas inlet 2013 and a second gas inlet 2014 are attached to the process gap 2011. There is an exhaust outlet 2015 between the first gas inlet 2013 and the second gas inlet 2014. It should be noted that in this embodiment, it is possible to have other process gas inlets connected to the process gap 2011 and/or to at least one of the supply chamber 2001 and the receiving chamber 2002. The functionality of the system 2000 will now be explained.

The system 2000 efficiently eliminates air/oxygen from the common space in the system through the use of vacuum before the reaction process is carried out on the workpiece 2020, but at the same time reduce the time needed to unload a processed workpiece roll from the receiving chamber 2002 and load a fresh or unprocessed workpiece roll into the supply chamber 2001. For example, when the reaction or processing of a roll of a first continuous workpiece is almost completed, the process is halted while still a portion (e.g. 2-4 meters long portion) of the first continuous workpiece is wrapped around the supply spool 2021. Next, as the doors (not shown) of the supply chamber 2001 and the receiving chamber 2002 are opened to access these ports, a first gas flow F30 and a second gas flow F31 are established and flowed into the process gap 2011 through the first gas inlet 2013 and the second gas inlet 2014, respectively. At the same time, an exhaust gas flow F32 is also established through the use of a vacuum pump 2023 of the exhaust system 2012 as described before. It should be noted that at this time, the system 2000 is equivalent to the previously described systems with the two ends (i.e. the entrance opening 2026 and the exit opening 2027) of the process gap 2011 open to air atmosphere. The exhaust flow F32 and the first and second gas flows F30 and F31 are chosen so that F32=(F34+F35)<(F30+F31), and a third gas flow F33 and a fourth gas flow F36 flow towards the supply chamber 2001 and the receiving chamber 2002, respectively. The third gas flow F33 and the fourth gas flow F36 are able to flow because the doors of the supply chamber 2001 and the receiving chamber 2002 are open to the atmosphere at this time. The third gas flow F33 and the fourth gas flow F34 constitute barriers against possible diffusion of air from the atmosphere into the central part (the part between the first gas inlet 2013 and the second gas inlet 2014) of the process gap 2011 through the entrance opening 2026 and the exit opening 2027. Therefore, a new roll of a second continuous workpiece wrapped around a second supply spool may now be loaded into the supply chamber 2001 and connected to the portion of the first continuous workpiece that extends to the receiving spool 2022 in the receiving chamber 2002. Then the first continuous workpiece 1105 is fully advanced into the receiving chamber 2002 while pulling a leading end of the second continuous workpiece into the receiving chamber 2002. In the following step, the processed workpiece or the first continuous workpiece is detached from the leading end of the second continuous workpiece and removed from the receiving chamber 2002 along with the receiving spool 2022 that it is wrapped around. Subsequently a second empty receiving spool is placed into the receiving chamber 2002 and the leading end of the second continuous workpiece is attached to the second receiving spool. The system would now be ready to process the fresh roll of the second workpiece. The roll to roll reaction may be initiated after the doors to the supply chamber 2001 and the receiving chamber 2002 are closed, the first gas flow F30, which is in this example an inert gas flow, and the second gas flow F31, which is also an inert gas flow, are shut down by valves (not shown), and the common space in the system is evacuated and then back filled with an inert gas as described before. As can be seen from the above description, the design of FIG. 20 allows the unloading of a processed roll and the loading of a new roll to be carried out when the two ends (the entrance opening 2026 and the exit opening 2027) of the process gap 2011 of the heated reactor are exposed to air. This accelerates the loading/unloading process and reduces the process preparation time. After loading the new or fresh roll, reaction of the newly loaded workpiece may be carried out after evacuation of the system to assure that no air is present in the process gap 2011.

FIG. 20A shows a section of another reactor system with a secondary exhaust 2013A connected to the process gap 2011 near the entrance opening 2026. In this configuration, during the loading/unloading of the roll of workpieces, a portion of the gas flow F30 is still directed towards the exhaust 2015 as the gas flow F34, and another portion is directed towards the supply chamber 2001 as gas flow F33. However, a secondary exhaust 2013A in this case pulls some of the gas flow F33 before it flows out through the entrance opening 2026. The gas flow F37 through the secondary exhaust 2013A is adjusted (through use of a vacuum pump connected to it as described before) such that F37=F33−F38, where F38 is the gas flow flowing out through the entrance opening. It should be noted that during the loading/unloading of rolls of workpieces, gas flows F38 and F33 form barriers against air/oxygen flow into the central section of the process gap 2011 and they can be adjusted at will. The configuration shown in FIG. 20A may also be used near the exit entrance 2027 of the system 2000 shown in FIG. 20. The gas inlet/gas exhaust configuration of FIG. 20A may be used to benefit the process during the reaction of a workpiece also. For example, excessive moisture interferes with the reaction of precursor layers used to form Group IBIIIAVIA compound semiconductors. In a roll to roll reactor, if moisture finds its way into the reactor it can reduce the photovoltaic properties of the absorbers formed as a result of the reaction process. Moisture absorbed on the surface of the long continuous workpiece which is loaded into the supply chamber of the reactor is the main source of this unwanted moisture. Such moisture, which may be chemisorbed or physisorbed and held on the workpiece surface including the precursor layer surface may be released from the workpiece surface as the portions of the workpiece enter the heated reactor and start heating up. This released moisture may then enter the reaction zone and influence the reaction. As the fresh roll is unwound and advanced into the reactor, more and more moisture may be introduced into the reaction atmosphere negatively impacting the reaction process. The design of FIG. 20A can be used to eliminate this problem as follows. The portion or section of the process gap 2011 in between the first gas inlet 2013 and the secondary exhaust 2013A (the pretreatment section 2030) is heated to a pre-treatment temperature that can help release the moisture adsorbed on the workpiece surface. This pre-treatment temperature may be in the range of 50-200° C., preferably in the range of 70-150° C. During the process, as the portions of a freshly loaded workpiece moves from the supply chamber 2001, through the entrance opening 2026 and into the pretreatment section 2030 of the process gap 2011, they get heated up. A moisture-free gas flow, such as an inert or reducing gas flow is established in the pretreatment section 2030, the gas flow entering through the first gas inlet 2013 and leaving through the secondary exhaust 2013A, and thus flowing in a direction opposite to the moving direction of the workpiece 2020. Applied heat and the gas flow over the workpiece portion in the pretreatment section 2030 help the moisture to desorb from the workpiece surface and the removed moisture is exhausted through the secondary exhaust 2013A. The portion of the workpiece that is substantially free from surface moisture then moves into the reaction zone of the system and gets reacted in a moisture-free environment. It should be noted that the gas used in the pre-treatment section 2030 may be an inert gas or a reducing gas comprising oxide-reducing species such as carbon monoxide and/or hydrogen. In that respect, in addition to reducing or eliminating moisture, the pre-treatment section 2030 may also reduce any unwanted oxide species in the precursor layer into metallic species. For example, any unwanted surface oxide, or bulk film oxide such as copper-oxide, indium-oxide, gallium oxide, selenium oxide may be reduced to their elemental form so that their reaction in the hotter sections of the process gap 2011 is efficient and yields good quality Group IBIIIAVIA compound absorber layers.

As mentioned above in the background, roll-to-roll or reel-to-reel processing increases throughput and minimizes substrate handling. Therefore, it is a preferred method for large scale manufacturing. Design of the reaction chamber to carry out selenization/sulfidation processes is critical for the quality of the resulting compound film, the efficiency of the solar cells, throughput, material utilization and the cost of the process. Further, the exhaust gases from such reactors contain Se and S which are environmentally unsafe materials and must be efficiently removed from the exhaust gas and recycled. Therefore, it is highly desirable to develop exhaust systems for efficient removal of Se and S from the exhaust gases of the reactors processing CIGS(S) materials. Such removed Se and/or S may also be re-used increasing materials utilization.

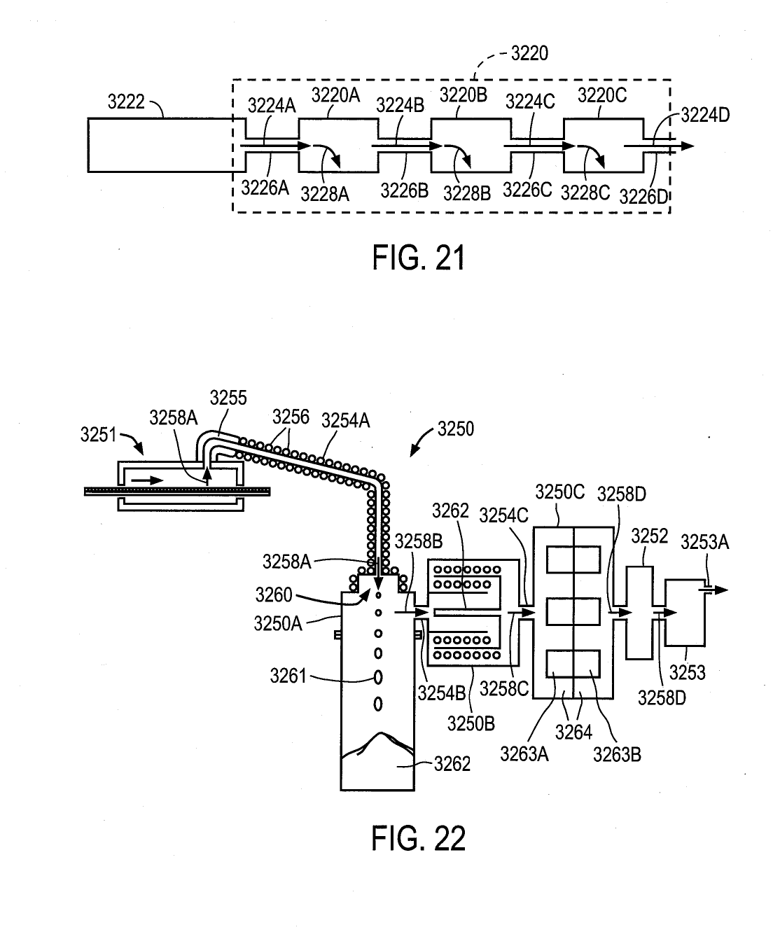

In another embodiment, a preferred reactor apparatus for processing precursor layers to form Group IBIIIAVIA absorber films to manufacture solar cells follows from the description of the reactors shown in FIG. 2, FIG. 4, FIG. 6, FIGS. 7A-9 and FIG. 13, and uses a reactor exhaust system 3220 shown in FIG. 21 to remove and process Se and/or S (from now on also referred to as Se/S vapor) containing gas or vapor species, such as vapors of Se and/or S, released during the reaction of various types of precursor layers employed to form Group IBIIIAVIA compounds. As discussed in more detail previously, such precursor layers include layers containing metallic Cu, In and Ga species and at least one of Se and S.

The reactor exhaust system 3220, which is placed to collect the exhaust gas from a reactor, such as exhaust 1116 of FIG. 13 above, but more generally shown in FIG. 21 as reactor 3222, may generally comprise a first material collector unit 3220A, a second material collector unit 3220B and a third material collector unit 3220C. The first material collector unit 3220A connect to the reactor 3222 through a first connector line 3226A so that a first flow 3224A of an exhaust gas including a carrier gas such as nitrogen gas (N₂) and a Se/S vapor is established towards an entrance of the first material collector unit 3220A that may be kept at temperature T₂ which is less than the temperature T₁ at the location where the first connector line 3226A and the reactor 3222 are physically joined together. As the exhaust gas flows towards the first material collector unit 3220A through the first connector line 3226A its temperature is reduced towards T₂ causing the Se/S vapor within the exhaust gas to turn into liquid. This way a majority, for example, preferably about 90%, of the Se/S vapor in the first flow 3224A of the exhaust gas liquefies and flows into the first material collector unit 3220A as a first precipitate 3228A. The first precipitate 3228A is made of Se and/or S and may be removed from the system at liquid state or, more preferably, it may be allowed to solidify at the bottom of the first material collector unit 3220A to be emptied at process intervals. This collected material may then be re-cycled and re-used.

Next, a second flow 3224B of the exhaust gas is flowed from the first material collector unit 3220A to the second material collector unit 3220B or the condenser unit through a second connector line 3226B. The second flow 3224B may include a smaller amount, for example up to about 8-10%, of the Se/S vapor originally contained in the first flow 3224A. The balance of the second flow 3224B is the carrier gas. In the condenser unit 3220B, the second flow 3224B comes in physical contact with a low temperature surface kept at temperature T₃ which is less than the temperature T₂. This low temperature causes the formation of a second precipitate 3228B on the low temperature surface. The second precipitate 3228B is made of Se and/or S which condenses in the condenser unit 3220B on the low temperature surface. The condenser unit 3220B may remove most of the remaining Se/S vapor, for example at least about 90% of the Se/S vapor that escaped the first material collector unit 3220A and was left in the second flow 3224B. The condenser unit may be cleaned off the collected Se/S at process intervals.

In the following step, a third flow 3224C of the exhaust gas is flowed from the condenser unit 3220B to the third material collector unit 3220C, which may be a filter unit, through a third connector line 3226C. The third flow 3224C may still include some residual Se and/or S. But since the temperature of the exhaust gas is low by this time, the Se and/or S in the third flow 3224C is typically in the form of small particles carried by the carrier gas. In the filter unit 3220C, the third flow 3224C is filtered to obtain a third precipitate 3228C from the exhaust gas. The third precipitate 3228C is made of Se and/or S solid particles and it is kept in the filter unit 3220C until emptied at process intervals.

A fourth flow 33224D of the exhaust gas leaving the filter unit 3220C through a fourth connector line 3226D is substantially free of Se and/or S and consists of almost entirely the carrier gas, e.g. N₂ gas. The fourth flow 3224D of the exhaust gas may directly open to atmosphere. In a preferred embodiment the fourth flow may be directed to a vacuum pump (not shown). In another preferred embodiment the fourth flow may first be directed to the inlet of a gas flow controller or a mass flow controller (not show) and the outlet of the mass flow controller maybe connected to an inlet of a vacuum pump. Of course various valves may be included in the system to make it more serviceable and practical.

It should be noted that the carrier gas may include, in addition to an inert gas, one or more reactive gases, such as H₂S and H₂Se. In this case the exhaust system described collects the portion of Se and/or S that may chemically break away from their respective gases (H₂Se and H₂S) and form Se and/or S vapor. However, portions of these gases that stay chemically intact pass through the first, second and third material collection units and may become part of the fourth flow 3224D since H₂S and H₂Se remain in gas form for temperatures used in the exhaust system of FIG. 21. Such temperatures are typically above 5° C., preferably above 10° C. for ease of use of the system. In this case, the fourth flow 3224D may be further directed to a chemical scrubber to scrub these H₂Se or H₂5 containing gases.

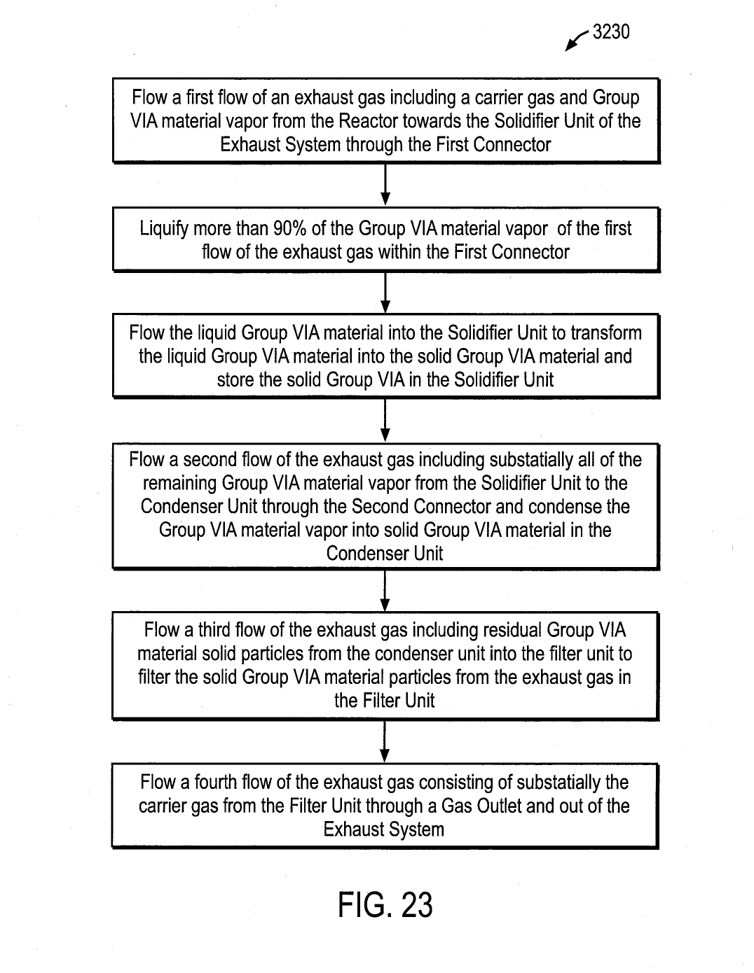

The flow chart 3230 shown in FIG. 23 further explains the steps of a preferred embodiment of a removal technique of Group VIA material vapors from an exhaust gas using the exhaust system 3220 of the present invention. Referring to FIGS. 21 and 23, the exhaust system 3220 may be used to remove Se (melting point about 220° C.) and/or S (melting point about 115° C.) vapor from the exhaust gas. However, the temperatures T₂ and T₃ are selected depending on the Group VIA material employed in the reactor 3222. For example, based on their melting temperatures, for Se removal, T₂ may be in the range of 250-650° C. and T₃ may be less than about 220° C., preferably much less than 220° C. For S removal, T₂ may be in the range of 120-650° C. and T₃ may be less than about 115° C., preferably much less than 115° C.

FIG. 22 shows an exemplary embodiment of an exhaust system 3250 to remove a Group VIA material, for example, Se from an exhaust gas produced in a process reactor 3251 used for forming Group IBIIIAVIA material layers from precursor films. As mentioned above, such exhaust gas includes a carrier gas such as N₂ gas, in addition to Se vapors. The exhaust system 3250 comprises a solidifier unit 3250A, a condenser unit 3250B and a filter unit 3250C. In this embodiment, the system 3250 may further comprise a mass flow controller 3252 unit, and a vacuum pump 3253 to create low pressure at the outlet of the mass flow controller 3252 and direct the exhaust gas flow from the outlet of the mass flow controller to the outlet of the pump. A first connector line between the reactor 3251 and the solidifier unit 3250A may be insulated partially or fully by an insulation layer 3255 and surrounded by heating elements 3256 to establish a temperature gradient between the temperature T₁ (in the range of 350-650° C., preferably in the range of 400-600° C.) at the location where the reactor and the connector line are joined, and the temperature T₂ (about in the range of 250-350° C.) at around the location where the first connector line is connected to the solidifier unit 3250A. As a first flow 3258A of the exhaust gas flows towards the solidifier 3250A, the Se vapor in the exhaust gas liquefies under the established temperature gradient. Preferably, an entrance 3260 where the connector line 3254A is attached to the solidifier unit 3250A may also be equipped with heat elements to keep the entrance at a temperature of about T₂ which is higher than the melting temperature of the collected Group VIA species (Se in this example) to prevent any solidification of Se at the entrance 3260. Such solidification, if it happens, would clog up the connector line 3254A at this point.

Referring to FIG. 22, the liquid selenium 3261 drips into the solidifier unit and collected at a bottom section of the solidifier unit 3250A as solid selenium 3262. The bottom section of the solidifier unit may be kept at a temperature less than T₂. The bottom section of the solidifier unit 3250A may be kept at around room temperature or may be lowered to a temperature such as 15-20° C. for efficient Se collection and it may be emptied at process intervals. The solid selenium 3262 may represent a large percentage, for example preferably at least 90%, of the total Se present in the first flow of the exhaust gas.

A second flow 3258B of the exhaust gas is flowed into the condenser unit 3250B through a second connector line 3254B. In this embodiment condenser unit 3250B includes a cooled surface 3262 for example a water cooled coil which may be kept at or below room temperature T₃. Interaction of the second flow 3258B of the exhaust gas with the cooled surface 3262 causes the condensation of most (for example preferably at least 90%) of the remaining Se vapor left in the second flow 3258B on the cooled surface 3262. The cooled surface 3260 holding the solid Se particles is cleaned at process intervals.

Despite the fact that most of the Se is removed in the solidifier unit 3250A and the condenser unit 3250B, some selenium particles may still be carried with the exhaust gas through the condenser unit 3250B. Such Se particles may be fully removed in the next step in the filter unit 3250C. Accordingly, a third flow 3258C of the exhaust gas is flowed into the filter unit 3250C through a third connector line 3254C to further remove any solid particles carried with the exhaust gas. In this embodiment filter unit preferably comprises several filters. For example, the filter unit 3250C may comprise a first set of coarse filters 3263A to collect large Se particles with a size above 50μ and a second set of fine filters 3263B to collect small Se particles with a size above 1μ. The third flow 3258C is first passed through the coarse filters 3263A and then the fine filters 3263C. Even more filters with finer particle catching properties may also be utilized. Se particles held by the filters 3263A and 3263B are collected in a filter trap 3264 which is cleaned at intervals. A fourth flow 3258 of the exhaust gas consists of the carrier gas and is substantially particle free. The fourth flow 3258 is directed towards the vacuum pump 3253 through the mass flow controller unit 3252. The pump establishes a pressure differential between the inlet and outlet of the mass flow controller by forming a vacuum at the outlet of the mass flow controller. It should be noted that the inlet of the mass flow controller may be at atmospheric pressure. Cleaned exhaust gas is released to the atmosphere through an outlet 3253A of the pump 3252. The exhaust system embodiments described above efficiently remove the Se or S from the exhaust gas and allow them to be reused through a recycling process.

Solar cells may be fabricated on the compound layers formed in the reactors of the present invention using materials and methods well known in the field. Once a compound layer is formed, for example a thin (<0.1 microns) CdS layer may be deposited on a top surface of the compound layer using the chemical dip method. A transparent window of ZnO layer may be deposited over the CdS layer using MOCVD or sputtering techniques. A metallic finger pattern is optionally deposited over the ZnO layer to complete the solar cell.

As mentioned above in the background, roll-to-roll or reel-to-reel processing increases throughput and minimizes substrate handling. Therefore, it is a preferred method for large scale manufacturing. Design of the reaction chamber to carry out selenization/sulfidation processes is critical for the quality of the resulting compound film, the efficiency of the solar cells, throughput, material utilization and the cost of the process. Further, as a high temperature process, CIGS reaction is easily fouled by moisture. In roll to roll processing reactors, moisture present in between the workpiece layers in a roll may make its way into the reactor during the loading of the unprocessed roll of the workpiece into the system. Moisture absorbed on the surface of the long workpiece is the main source of this unwanted moisture. Such moisture, which may be chemisorbed or physisorbed and held on the workpiece surface can be released from the workpiece surface as the portions of the workpiece enter the heated reactor and start heating up. This released moisture may then enter the reaction zone and influence the reaction. As the unprocessed roll is unwound and advanced into the reactor, more and more moisture may be introduced into the reaction atmosphere negatively impacting the reaction process. Therefore, it is highly desirable to develop moisture removal techniques and apparatus for efficient removal of moisture from the workpieces before processing CIGS(S) forming precursor materials in the reactors.

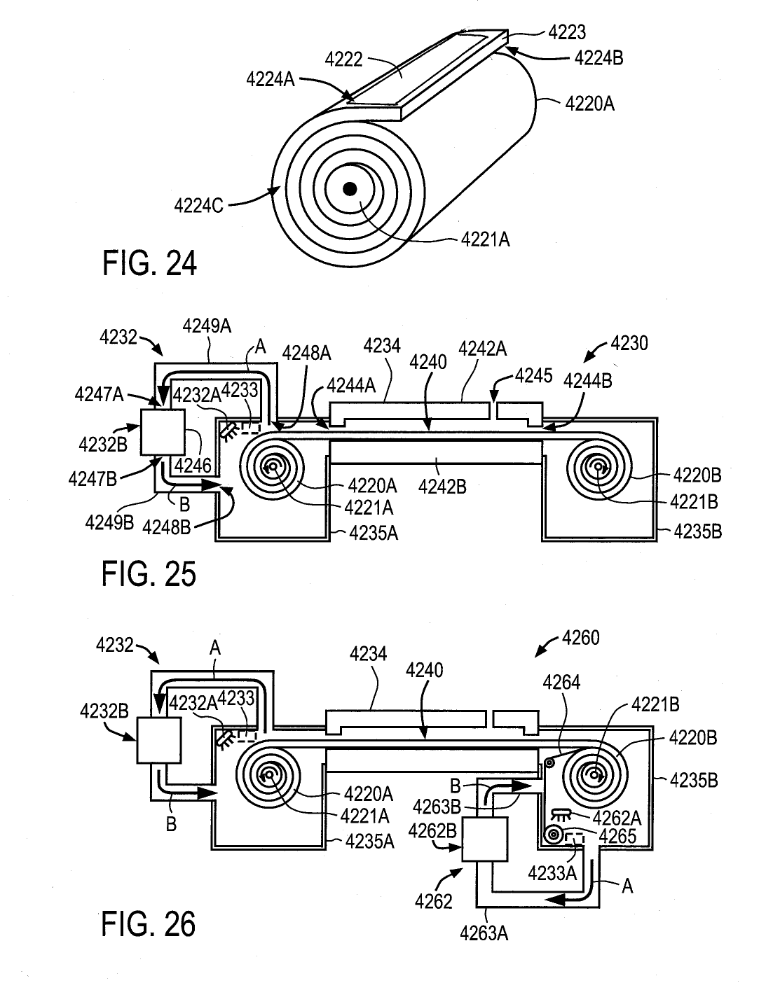

As mentioned above, a fresh roll or unprocessed roll is the main source of unwanted moisture entry into roll to roll reactors. FIG. 24 shows in perspective not-to-scale view an exemplary roll of an unprocessed workpiece 4220A wrapped around a supply spool or roller 4221A, which is ready to be loaded into a supply chamber or unwind chamber or unwind port (also called first port) of a reactor. A front surface 4224A of the unprocessed workpiece includes a precursor layer 4222 formed on a flexible base material 4223. Moisture, in the form of water molecules, may attach itself over all major surfaces, namely the front surface 4224A and a back surface 4224B and minor surfaces, namely side surfaces 4224C of the workpiece. This moisture may be chemically attached (chemisorbed) or physically attached (physisorbed) on such surfaces. If this moisture is not removed, it can be released into the reactor during the reacting stage of the precursor layer 4222.

Accordingly, in an embodiment, a preferred reactor system 4230 for processing precursor layers to form Group IBIIIAVIA absorber films to manufacture solar cells, follows from the description of the reactors shown in FIG. 2, FIG. 4, FIG. 6, FIGS. 7A-9 and FIG. 13, and uses a moisture removal unit 4232, which is attached to a reactor 4234, shown in FIG. 25 to pre-treat the workpiece for removing the moisture on it before advancing the workpiece into the reactor.

The moisture removal unit 4232 getters the moisture, collecting it before the moisture finds its way into the reaction process gap. As shown in FIG. 25, in this embodiment, a supply chamber moisture removal unit 4232 may includes a first device 4232A or a moisture desorption device and a second device 4232B or a moisture absorption device which may be attached to or contained inside the interior of the supply chamber 4235A or unwind port where the unprocessed workpiece 4220A (see also FIG. 24) is unwound from the supply spool 4221A and advanced through a process gap 4240 of the reactor 4234. Processing the precursor 4222 in the process gap 4240 transforms the unprocessed workpiece 4220A into a processed workpiece 4220B that is taken out and wound around a receiving spool or roller 4221B in a receiving chamber 4235B or a rewind port (also called second port). The supply and receiving chambers 4235A and 4235B are sealably attached to the reactor 4234 at both ends. As described above, during the reaction, the precursor layer 4222 transforms into a Group IBIIIAIVA absorber layer. As also described in the previous embodiments, the reactor includes a top wall 4242A, bottom wall 4242B and side walls (not shown). The workpiece 4220 enters the process gap 4240 through an entrance opening 4244A of the process gap 4240 and exits the process gap through an exit opening 4244B of the process gap. Exhaust gases formed during the reaction in the process gap are taken out through an exhaust outlet 4245.

Referring to FIG. 25, the moisture desorption device 4232A may be an energy source to apply a form of energy to the workpiece 4220A to drive moisture off the workpiece by applying energy to the surfaces of the unprocessed workpiece 4220A, as the unprocessed workpiece is unwound in the supply chamber 4235A. The energy source 4232A may be located in the supply chamber 4235A. Alternatively, the energy source 4232A may be located outside (not shown) the supply chamber 4235A and a window may be fitted, permitting the transfer of energy from the energy source through the window and onto the surface of the unprocessed workpiece 4220A. Exemplary energy sources may include ultraviolet (UV) lamps, infrared lamps, microwave emitters, RF induction sources, and the like. In this embodiment, a preferable moisture desorption device is a UV lamp. The water vapor removed from the unprocessed workpiece 4220A is circulated through the moisture absorption device 4232B and removed from the system.

The moisture absorption device 4232B may have a container 4246 including a first opening 4247A and a second opening 4247B. The first opening 4247A of the container 4246 is sealably connected to a first opening 4248A of the supply chamber 4235A by a first duct 4249A, and the second opening 4247B is sealably connected to a second opening 4249B of the supply chamber by a second duct 4248B. During the process, a moisture containing carrier gas flows into the moisture absorption device from the supply chamber in the direction of arrow ‘A’, and a moisture free carrier gas returns to the supply chamber 4235A in the direction of arrow Gas flow may be induced by a pump (not shown) attached to the moisture removal unit 4232. A moisture absorption material such as a desiccant including, for example, one of silica gel, cobalt chloride and calcium sulfate is kept in the container 4246 to absorb the water vapor as it flows through the moisture absorption device. The desiccant may be supplied in moisture permeable bags which can be replaced with dry ones at process intervals. Alternatively the container 4246 may be filled with a desiccant material. At the process intervals, either the used desiccant or the container 4246 containing the desiccant is replenished. In this case, the first and second openings may be covered with gas and moisture permeable membranes. Passive room-temperature desiccants such as silica gel, cobalt chloride or calcium sulfate may also be used as moisture absorption materials. Other passive desiccation means include, but are not limited to titanium or other reactive metal filings which may be heated in the supply chamber 4235A. Alternatively, such heating may be located in the moisture absorption device 4232B.

It should be noted that instead of using the moisture removal unit 4232, it is possible to simply place the moisture absorption material in a permeable container 4233 (depicted with dotted lines) in the supply chamber 4235A and let moisture diffuse to the moisture absorption material to get adsorbed. In the supply chamber 4235A, the permeable container 4233 is preferably kept between the moisture desorption device 4232A and the entrance opening 4244A as shown in FIG. 25 and is replaced at process intervals. Also it is possible to use more than one moisture desorption device 4232A. For example, two such devices may be used to desorb moisture from the front surface 4224A and the back surface 4224B of the unprocessed workpiece 4220A (FIG. 24).

Referring to FIG. 25, in one process sequence, first the unprocessed workpiece 4220A is loaded into the supply chamber 4235A; advanced through the process gap 4240; and attached to the receiving roller 4221B. Next, both the supply chamber 4235A and the receiving chamber 4235B are closed and sealed, pumping and purging with an inert gas is carried out as described before, and the reaction process is initiated as the workpiece starts to unwind from the supply spool 4221A and rewind on the receiving spool 4221B. The moisture desorption device 4232A and the moisture absorption device 4232B are activated while an inert gas such as N₂ is flowed into the supply chamber 4235A, and circulated between the supply chamber and the moisture absorption device 4232B by flowing it through the first duct 4249A, the moisture absorption device 4232B, the second duct 4249B, the supply chamber 4235A and again back to the first duct 4249A. As the energy from the moisture desorption device 4232A releases the moisture on the surface of the unwinding workpiece as water vapor, this vapor is carried by the circulating N₂ to the moisture absorption device 4232B and is removed by the moisture absorbing material. This process continues as all the unprocessed workpiece 4220A is unwound and reacted in the process gap and the processed workpiece 4220B is wrapped around the receiving roller 4221B in the receiving chamber 4235B.

FIG. 26 shows a reactor system 4260 including two moisture removal units. The system 4260 is constructed by attaching a receiving chamber moisture removal unit 4262 to the receiving chamber 4235B of the reactor system 4230 shown in FIG. 25. In this embodiment, the purpose of having a moisture removal unit 4262 attached to the receiving chamber 4235B is to remove any moisture which may be introduced by an auxiliary supply material placed in the receiving chamber. For example, as shown in FIG. 26, an exemplary auxiliary supply material includes, but not limited to, a protective sheet material 4264 or interleaf which is unwound from a roll 4265 and rewrapped with the processed workpiece 4220B as the processed workpiece is wrapped around the receiving roll 4221B or spool. The protective sheet material 4264, which may be paper or polymer film, prevents the processed workpiece 4220B from scratching itself as it is rewound.

The receiving chamber moisture removal unit 4262 may include a first device 4262A or moisture desorption device which is an energy source and a second device 4262B or a moisture absorption device. The moisture desorption device 4262A is preferably located in the receiving chamber 4235B and adjacent the roll 4265 of the protective sheet material 4264. As in the above embodiment, the moisture desorption device 4262A may be located outside the receiving chamber and a window may be fitted, permitting the transfer of energy from the moisture desorption device 4262A to the workpiece 4220B through the window.

The moisture absorption device 4262B is connected to the receiving chamber externally by a first duct 4263A and a second duct 4263B. The receiving chamber moisture removal unit 4262 functions the same as the supply chamber moisture removal unit 4232. Alternatively, also in this embodiment, the moisture absorption device 4262B may be replaced with a permeable container 4233A, which is similar to the permeable container 4233 described in the above embodiment containing a moisture absorbing material, e.g., desiccant. In the above embodiment, either the moisture absorption device 4262B or the permeable container 4233A works together with the moisture desorption device to capture the water vapor released by the moisture desorption device 4262A. However, either the moisture absorption device 4262B or the permeable container 4233A may be used without having the moisture desorption device 4262A and this is within the scope of this invention.

Although the present invention is described with respect to certain preferred embodiments, modifications thereto will be apparent to those skilled in the art.

1. An apparatus used to react a precursor material disposed over a sheet-shaped continuous workpiece to form a solar cell absorber, the apparatus comprising:
a process gap defined by a peripheral wall, wherein the sheet-shaped continuous workpiece travels between an entry opening and an exit opening of the process gap, wherein within the process gap a reaction process is used to form the solar cell absorber from the precursor material on the sheet-shaped continuous workpiece;
an unwind port sealably attached to the entry opening of the process gap, wherein the unwind port includes an unwind chamber with a supply roll disposed therein from which the sheet-shaped continuous workpiece is advanced into the process gap through the entrance opening;
a rewind port sealably attached to the exit opening of the process gap, wherein the rewind port includes a rewind chamber with a receiving roll disposed therein that receives and wraps therearound the sheet-shaped continuous workpiece from the process gap through the exit opening; and
a first moisture removal unit that operates in conjunction with the unwind port and includes:
a moisture desorption device to remove moisture from the sheet-shaped continuous workpiece as the sheet-shaped continuous workpiece is unwound from the supply roll disposed within the unwind chamber, wherein the moisture removed from the sheet-shaped continuous workpiece is contained within the unwind chamber, and
a moisture absorption device to remove the moisture that is contained within the unwind chamber from the unwind chamber.

2. The apparatus of claim 1, wherein the moisture desorption device is an energy source that applies energy to the sheet-shaped continuous workpiece in the unwind chamber of the unwind port to remove the moisture.

3. The apparatus of claim 2, wherein the moisture desorption device is disposed inside the unwind chamber of the unwind port, adjacent the supply roll.

4. The apparatus of claim 2, wherein the moisture desorption device is disposed outside the unwind chamber of the unwind port and applies energy to the sheet-shaped continuous workpiece within the unwind chamber of the unwind port through a transparent window of the unwind port.

5. The apparatus of claim 2, wherein the moisture desorption device comprises one of an ultraviolet (UV) lamp, an infrared lamp, a microwave emitter and a RF induction source.

6. The apparatus of claim 1, wherein the moisture absorption device includes a moisture absorption material to absorb the moisture.

7. The apparatus of claim 6, wherein the moisture absorption material is maintained in a permeable container.

8. The apparatus of claim 7, wherein the permeable container is disposed inside the unwind chamber of the unwind port adjacent the supply roll.

9. The apparatus of claim 7, wherein the permeable container is disposed outside the unwind port and connects to the unwind chamber of the unwind port through a first gas line and a second gas line, wherein a first gas flow carrying the moisture flows from the unwind chamber through the first gas line to the permeable container, and a second gas flow having substantially less moisture flows from the permeable container to the unwind chamber through the second gas line.

10. The apparatus of claim 9, wherein the first moisture absorption device includes a gas pump to induce the first and second gas flows.

11. The apparatus of claim 6, wherein the moisture absorption material is a desiccant including one of silica gel, cobalt chloride and calcium sulfate.

12. The apparatus of claim 6, wherein the moisture absorption system consists of a furnace and a reactive getter which is heated by a heat source, and wherein the reactive getter is made of one of Mg and Ti.

13. The apparatus of claim 12, wherein the reactive getter is at least one of wire, mesh and filling.

14. The apparatus of claim 1 further comprising a second moisture removal unit to remove moisture from the rewind port, the second moisture removal unit including:
another moisture desorption device to remove moisture from components within the rewind chamber as the sheet-shaped continuous workpiece is wound onto the receiving roll, wherein the moisture removed from the components is contained within the rewind chamber, and
another moisture absorption device to remove the moisture that is contained within the rewind chamber from the rewind chamber.

15. The apparatus of claim 14, wherein the moisture absorption device includes a moisture absorption material to absorb the moisture maintained in a permeable container; and
wherein the another moisture absorption device includes another moisture absorption material to absorb the moisture maintained in another permeable container.

16. The apparatus of claim 15, wherein the permeable container is disposed inside the unwind chamber of the unwind port adjacent the supply roll. and wherein the another permeable container is disposed inside the rewind chamber of the rewind port adjacent the receiving roll.

17. The apparatus of claim 15, wherein the permeable container is disposed outside the unwind port and connects to the unwind chamber of the unwind port through a first gas line and a second gas line, wherein a first gas flow carrying the moisture flows from the unwind chamber through the first gas line to the permeable container, and a second gas flow having substantially less moisture flows from the permeable container to the unwind chamber through the second gas line; and
wherein the another permeable container is disposed outside the rewind port and connects to the rewind chamber of the rewind port through a third gas line and a fourth gas line, wherein a third gas flow carrying the moisture flows from the rewind chamber through the third gas line to the another permeable container, and a fourth gas flow having substantially less moisture flows from the another permeable container to the rewind chamber through the fourth gas line.

18. The apparatus of claim 17, wherein the first moisture absorption device includes a gas pump to induce the first and second gas flows, and wherein the second moisture absorption device includes another gas pump to induce the third and fourth gas flows.

19. An exhaust system to remove Group VIA material vapors from a reactor used to process precursor layers to form Group IBIIIAVIA compound thin films for solar cells, the reactor including an exhaust outlet, the exhaust system comprising:
a first material collector unit, including a collector, adapted to connect to the exhaust outlet of the reactor through a first connector line to receive a first exhaust gas flow from the reactor, wherein the first exhaust gas flow includes at least one Group VIA material vapor and a carrier gas, and wherein the first connector line is maintained at a second temperature that is lower than a first temperature of the exhaust outlet so that a first amount of the Group VIA material carried by the first exhaust gas flow liquefies and flows into the collector thereby forming a first precipitate of the Group VIA material within the first material collector unit;
a second material collector unit, including a condenser, connected to the first material collector unit through a second connector line to receive a second exhaust gas flow from the first material collector, wherein a second amount of the Group VIA material carried by the second exhaust gas flow is condensed by the condenser maintained at a third temperature that is lower than the second temperature so as to form a second precipitate within the second material collector unit, and wherein the second amount of the Group VIA material is less than the first amount of the Group VIA material;
a third material collector unit, including a filter, connected to the second material collector unit through a third connector line to receive a third exhaust gas flow from the second material collector, and wherein a third amount of the Group VIA material carried by the third exhaust gas flow is filtered by the filter so as to collect a third precipitate in the filter, and wherein the third amount of the Group VIA material is less than the second amount of the Group VIA material; and
wherein a fourth exhaust gas flow leaves the third material collector through a fourth connector line, and wherein the fourth exhaust gas flow is the carrier gas that is substantially free of the Group VIA material.

20. The system of claim 19, wherein the fourth connector line is directly open to atmosphere to release the fourth exhaust gas flow to atmosphere.

21. The system of claim 19, wherein the fourth connector line is connected to a vacuum system.

22. The system of claim 19, wherein the fourth connector line is connected to an inlet of a mass flow controller.

23. The system of claim 22, wherein an outlet of the mass flow controller is connected to a vacuum system.

24. The system of claim 19, wherein the collector includes a heater and maintains the Group VIA material in the liquid form.

25. The system of claim 19, wherein the collector is a solidifier, including a collector cooler, and solidifies the Group VIA material.

26. The system of claim 25, wherein the first connector line is connected to an inlet opening of the first material collector unit.

27. The system of claim 26, wherein heating elements are disposed along an outer surface of the first connector line and adjacent the inlet opening to maintain the temperature of the first connecter and the inlet opening at the first second temperature.

28. The system of claim 26, wherein an insulation layer coats an outer surface of the first connector line and the inlet opening to maintain the temperature of the first connecter and the inlet opening at the second temperature.

29. The system of claim 25, wherein the collector cooler is one of a water cooler and an air cooler.

30. The system of claim 19, wherein the condenser is a plate, attached to a condenser cooler, and the Group VIA material condenses on a surface of the plate.

31. The system of claim 30, wherein the condenser cooler is one of a water cooler and an air cooler.

32. The system of claim 19, wherein an insulation layer coats the first connector line to maintain the temperature of the first connecter at the second temperature.

33. The system of claim 19, wherein an insulation layer coats an outer surface of the first connector line to maintain the temperature of the first connecter line at the second temperature.

34. The system of claim 19, wherein heating elements disposed along an outer surface of the first connector line to maintain the temperature of the first connecter at the second temperature.

35. The system of claim 19, wherein the Group VIA material includes at least one of selenium (Se) and sulfur (S) and the carrier gas includes at least one of argon (Ar) and nitrogen (N₂).

36. The system of claim 35, wherein the first temperature is in the range of 350-600° C.

37. The system of claim 36, wherein the second temperature is in the range of 221-350° C. for Se.

38. The system of claim 36, wherein the second temperature is in the range of 115-350° C. for S.

39. The system of claim 36, wherein the third temperature is in the range of 10-100° C.

40. The system of claim 19, wherein the first amount of Group VIA material is less than 90% of the Group VIA material delivered by the first exhaust gas flow.

41. The system of claim 19, wherein the second amount of Group VIA material is less than 10% of the Group VIA material delivered by the first exhaust gas flow.

42. The system of claim 19, wherein the third amount of Group VIA material is less than 1% of the Group VIA material delivered by the first exhaust gas flow.
